(19) United States
(12) Patent Application Publication
(10) Pub. No.: US 2024/0179193 A1
(43) Pub. Date: May 30, 2024

(54) CHANNEL RECOMMENDATIONS USING MACHINE LEARNING

(71) Applicant: Salesforce, Inc., San Francisco, CA (US)

(72) Inventors: Aaron Maurer, New York, NY (US); Fiona Condon, Brooklyn, NY (US); Kyle Jablon, Long Island City, NY (US); Maxwell Hayman, Mill Valley, CA (US); Lichen Ni, Vancouver (CA); Huai Yu Frederick Huang, Hillsborough, CA (US)

(21) Appl. No.: 18/072,195

(22) Filed: Nov. 30, 2022

(51) Int. Cl. H04L 65/401; G06F 40/279; G06N 20/00; H04L 67/306

(52) U.S. Cl. CPC H04L 65/4015; G06F 40/279; G06N 20/00; H04L 67/306

(57) ABSTRACT

Techniques for generating user profile data including one or more frequent channels, related users, and/or related topics within a communication platform are discussed herein. In some examples, a machine-learning model can receive user interaction data (messages sent, messages read, channel posts, documents shared, frequent key words used, etc.) associated with the communication platform and output one or more frequent channels, related users, and/or related topics. The communication platform may then associate the one or more frequent channels, related users, and/or related topics with the user's profile data. In some examples, the communication platform may present different frequent channels, related users, and/or related topics associated with a profile page based on interaction action associated with the user account viewing the profile page.

### TECHNICAL FIELD

Communication platforms are popular for facilitating work-related communications, such as for transparent project collaboration between users. A user may often interact with a large number of other users on the communication platform when working on projects, sharing information, participating in virtual meetings, or engaging in synchronous or asynchronous discussions. However, especially in cases where there are large volumes of users and/or projects, a user may not be aware of relevant projects other users are working on, or who other relevant users may be collaborating with. Existing systems make it difficult to capture accurate user networks for individual users over time.

### BRIEF DESCRIPTION OF THE DRAWINGS

The detailed description is described with reference to the accompanying figures. In the figures, the leftmost digit of a reference number identifies the figure in which the reference number first appears. The use of the same reference numbers in different figures indicates similar or identical components or features. The figures are not drawn to scale.

FIG. 1 illustrates an example system for performing techniques described herein.

FIG. 2A illustrates a user interface for a group-based communication system for certain examples.

FIG. 2B illustrates a user interface for multimedia collaboration sessions within the group-based communication system for certain examples.

FIG. 2C illustrates a user interface for inter-organization collaboration within the group-based communication system for certain examples.

FIG. 2D illustrates a user interface for collaborative documents within the group-based communication system for certain examples.

FIG. 3A depicts a user interface for workflows within a group-based communication system;

FIG. 3B depicts a block diagram for carrying out certain examples, as discussed herein.

FIG. 4 illustrates an example user interface associated with a communication platform, as described herein, for displaying a user profile including frequent channels, related people, and frequent topics.

FIG. 5 illustrates example first and second user interfaces associated with a communication platform, as described herein, for displaying a user profile including frequent channels, related people, and frequent topics.

FIG. 6 is a flow diagram illustrating an example process of generating data associated with representative channels and representative users using machine-learning model(s) as described herein.

FIG. 7 is a flow diagram illustrating an example process for training machine-learning model(s) as described herein.

### DETAILED DESCRIPTION

This disclosure describes techniques for generating or otherwise determining frequent channels, related users, and/or frequent topics to be displayed in association with a user's profile page. As described herein, machine-learning models may be trained and used to determine one or more channels a user is active in or manages, user accounts the user frequently interacts with or is associated with, and/or topics a user frequently discusses or may be knowledgeable in. The communication platform may input a user's prior interactions associated with using the communication platform into a machine-learning model and receive, as output from the machine-learning model, frequent channels the user interacts with, related users, and/or frequent topics the user discusses. In some examples, a user's prior interactions (described as interaction data) may include a user's interactions with the user's own profile page, other users, channels, posts, documents, etc. In some examples, a user's prior interactions may include reactions to messages, links associated with messages, a number of messages sent to a user, a number of replies associated with a channel, documents, or attachments within a channel, etc. A user's interactions with the communication platform may also include a number of shared channels between the user and individual users, activity level associated with individual users within shared channels, user reply data associated with individual users, or a number of keywords or key phrases used by individual users.

In some examples, a machine-learning model may be trained to output one or more frequent channels associated with a user account. For example, the communication platform may input user interaction data into the machine-learning model and receive, as output, one or more frequent channels the user account frequently interacts with or manages. In some examples, the communication platform may associate the one or more frequent channels with the user's profile data. In some examples, the communication platform may present one or more recommended channels to a user to accept prior to associating the one or more channels with the user's profile data. In some examples, the machine-learning model may assign a confidence score to individual channels represented on a user profile. The communication platform may then determine an order to present the channels based on the confidence score.

In some examples, a machine-learning model may be trained to output one or more related users associated with a user account. For example, the communication platform may input user interaction data into a machine-learning model and receive, as output, one or more related users the user account is associated with or frequently interacts with. In some examples, the communication platform may associate the one or more related users with the user's profile data. In some examples, the communication platform may present one or more recommended user accounts to a user to accept prior to associating the one or more channels with the user's profile data. In some examples, the machine-learning model may assign a confidence score to individual users represented on a user profile. The communication platform may then determine an order to present the users based on the confidence score.

In some examples, a machine-learning model may be trained to output one or more frequently discussed topics associated with a user account. For example, the communication platform may input a keyword or key phrase into the machine-learning model and receive, as output, one or more frequently discussed topics associated with a user account. In some examples, the communication platform may associate the one or more frequently discussed topics with a user's profile data. In some examples, the communication platform may present the one or more frequently discussed topics to a user to accept prior to associating the one or more frequently discussed topics with the user's profile data. In some examples, the machine-learning model may assign a confidence score to topics represented on a user profile. The communication platform may then determine an order to present the topics based on the confidence score.

In some examples, a machine-learning model may generate data representing one or more frequent channels and/or related users based at least in part on a number of frequent channels and/or related users already associated with a user's profile data. For example, a user's profile may be associated with a maximum number of frequent channels and/or related users. The maximum number of frequent channels and/or related users that may be presented on a user's profile page may be set by the communication platform, an organization, an administrator, or a user. A profile page associated with a maximum number of frequent channels and/or related users may be updated over time to include new frequent channels and/or new related users while replacing previous frequent channels and/or related users. For example, the machine-learning model may recommend new frequent channels and/or new related users to the user based on new interaction data input into the machine-learning model over time. In some examples, the machine-learning model may update frequent channels and/or related users associated with a profile page based on a user's request to modify the profile data, detecting a threshold number of keywords or key phrase associated with the user or user account, or a threshold period of time elapsing.

In some examples, the communication platform may present different profile data to users based at least in part on interaction data between the different users. For example, the machine-learning model may be trained to output different profile data based at least in part on interaction data associated with the viewing user and the user account associated with the profile data, the viewing user's preferences or interests, or permissions or privacy setting associated with the profile data. In some examples, the communication platform may rearrange, based in part on outputs received from the machine-learning model, one or more frequent channels, users, and/or topics associated with profile data depending on the interaction data associated with the user account that is viewing the user account's profile data.

As discussed above, in existing technologies, users may be required to review large amounts of data (e.g., messages, channels, etc.) in order to get an idea of who people are working with or which users to collaborate with on a project. Users may interact with a large number of users over the course of time. Regularly updating a profile page may be cumbersome and requiring users to manually update profile information may lead to unreliable information, especially in organizations that have thousands of employees. To address the technical problems and inefficiencies of searching for helpful user information or finding users to collaborate with on projects, the techniques described herein may include using one or more machine-learning models to determine frequent channels, related users, and/or frequent topics associated with individual users and, in some examples, automatically associated the frequent channels, related users, and/or frequent topics with a user's profile data. The technical solutions discussed herein solve technical problems associated with the presence of voluminous amounts of user interaction information stored in the history of a communication platform as well as dealing with frequently changing information.

The following detailed description of examples references the accompanying drawings that illustrate specific examples in which the techniques can be practiced. The examples are intended to describe aspects of the systems and methods in sufficient detail to enable those skilled in the art to practice the techniques discussed herein. Other examples can be utilized and changes can be made without departing from the scope of the disclosure. The following detailed description is, therefore, not to be taken in a limiting sense. The scope of the disclosure is defined only by the appended claims, along with the full scope of equivalents to which such claims are entitled.

### Group-Based Communication System

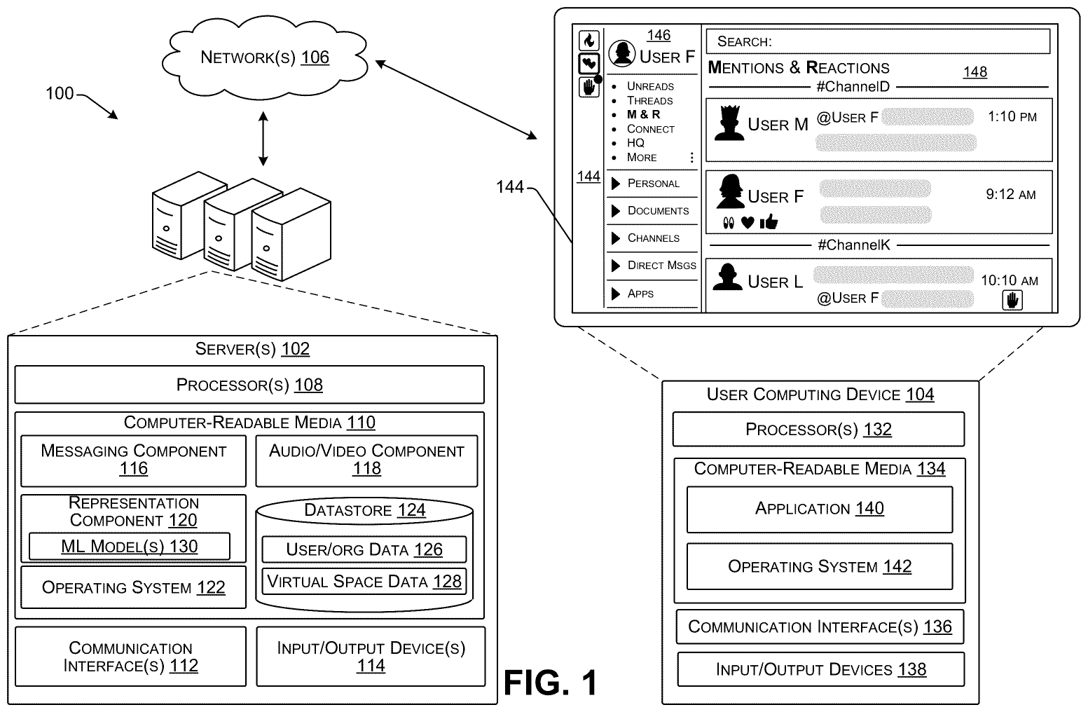

FIG. 1 illustrates an example environment 100 for performing techniques described herein. In at least one example, the example environment 100 can be associated with a communication platform that can leverage a network-based computing system to enable users of the communication platform to exchange data. In at least one example, the communication platform can be “group-based” such that the platform, and associated systems, communication channels, messages, collaborative documents, canvases, audio/video conversations, and/or other virtual spaces, have security (that can be defined by permissions) to limit access to a defined group of users. In some examples, such groups of users can be defined by group identifiers, as described above, which can be associated with common access credentials, domains, or the like. In some examples, the communication platform can be a hub, offering a secure and private virtual space to enable users to chat, meet, call, collaborate, transfer files or other data, or otherwise communicate between or among each other. As described above, each group can be associated with a workspace, enabling users associated with the group to chat, meet, call, collaborate, transfer files or other data, or otherwise communicate between or among each other in a secure and private virtual space. In some examples, members of a group, and thus workspace, can be associated with a same organization. In some examples, members of a group, and thus workspace, can be associated with different organizations (e.g., entities with different organization identifiers).

In at least one example, the example environment 100 can include one or more server computing devices (or “server(s)”) 102. In at least one example, the server(s) 102 can include one or more servers or other types of computing devices that can be embodied in any number of ways. For example, in the example of a server, the functional components and data can be implemented on a single server, a cluster of servers, a server farm or data center, a cloud-hosted computing service, a cloud-hosted storage service, and so forth, although other computer architectures can additionally or alternatively be used.

In at least one example, the server(s) 102 can communicate with a user computing device 104 via one or more network(s) 106. That is, the server(s) 102 and the user computing device 104 can transmit, receive, and/or store data (e.g., content, information, or the like) using the network(s) 106, as described herein. The user computing device 104 can be any suitable type of computing device, e.g., portable, semi-portable, semi-stationary, or stationary. Some examples of the user computing device 104 can include a tablet computing device, a smart phone, a mobile communication device, a laptop, a netbook, a desktop computing device, a terminal computing device, a wearable computing device, an augmented reality device, an Internet of Things (IOT) device, or any other computing device capable of sending communications and performing the functions according to the techniques described herein. While a single user computing device 104 is shown, in practice, the example environment 100 can include multiple (e.g., tens of, hundreds of, thousands of, millions of) user computing devices. In at least one example, user computing devices, such as the user computing device 104, can be operable by users to, among other things, access communication services via the communication platform. A user can be an individual, a group of individuals, an employer, an enterprise, an organization, and/or the like.

The network(s) 106 can include, but are not limited to, any type of network known in the art, such as a local area network or a wide area network, the Internet, a wireless network, a cellular network, a local wireless network, Wi-Fi and/or close-range wireless communications, Bluetooth®, Bluetooth Low Energy (BLE), Near Field Communication (NFC), a wired network, or any other such network, or any combination thereof. Components used for such communications can depend at least in part upon the type of network, the environment selected, or both. Protocols for communicating over such network(s) 106 are well known and are not discussed herein in detail.

In at least one example, the server(s) 102 can include one or more processors 132, computer-readable media 110, one or more communication interfaces 112, and/or input/output devices 114.

In at least one example, each processor of the processor(s) 132 can be a single processing unit or multiple processing units, and can include single or multiple computing units or multiple processing cores. The processor(s) 132 can be implemented as one or more microprocessors, microcomputers, microcontrollers, digital signal processors, central processing units (CPUs), graphics processing units (GPUs), state machines, logic circuitries, and/or any devices that manipulate signals based on operational instructions. For example, the processor(s) 132 can be one or more hardware processors and/or logic circuits of any suitable type specifically programmed or configured to execute the algorithms and processes described herein. The processor(s) 132 can be configured to fetch and execute computer-readable instructions stored in the computer-readable media, which can program the processor(s) to perform the functions described herein.

The computer-readable media 110 can include volatile and nonvolatile memory and/or removable and non-removable media implemented in any type of technology for storage of data, such as computer-readable instructions, data structures, program modules, or other data. Such computer-readable media 110 can include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired data and that can be accessed by a computing device. Depending on the configuration of the server(s) 102, the computer-readable media 110 can be a type of computer-readable storage media and/or can be a tangible non-transitory media to the extent that when mentioned, non-transitory computer-readable media exclude media such as energy, carrier signals, electromagnetic waves, and signals per se.

The computer-readable media 110 can be used to store any number of functional components that are executable by the processor(s) 132. In many implementations, these functional components comprise instructions or programs that are executable by the processor(s) 132 and that, when executed, specifically configure the processor(s) 132 to perform the actions attributed above to the server(s) 102. Functional components stored in the computer-readable media can optionally include a messaging component 116, an audio/video component 118, a representation component 120 including machine-learning model(s) 130, an operating system 122, and a datastore 124.

In at least one example, the messaging component 116 can process messages between users. That is, in at least one example, the messaging component 116 can receive an outgoing message from a user computing device 104 and can send the message as an incoming message to a second user computing device 104. The messages can include direct messages sent from an originating user to one or more specified users and/or communication channel messages sent via a communication channel from the originating user to the one or more users associated with the communication channel. Additionally, the messages can be transmitted in association with a collaborative document, canvas, or other collaborative space. In at least one example, the canvas can include a flexible canvas for curating, organizing, and sharing collections of information between users. In at least one example, the collaborative document can be associated with a document identifier (e.g., virtual space identifier, communication channel identifier, etc.) configured to enable messaging functionalities attributable to a virtual space (e.g., a communication channel) within the collaborative document. That is, the collaborative document can be treated as, and include the functionalities associated with, a virtual space, such as a communication channel. The virtual space, or communication channel, can be a data route used for exchanging data between and among systems and devices associated with the communication platform.

In at least one example, the messaging component 116 can establish a communication route between and among various user computing devices, allowing the user computing devices to communicate and share data between and among each other. In at least one example, the messaging component 116 can manage such communications and/or sharing of data. In some examples, data associated with a virtual space, such a collaborative document, can be presented via a user interface. In addition, metadata associated with each message transmitted via the virtual space, such as a timestamp associated with the message, a sending user identifier, a recipient user identifier, a conversation identifier and/or a root object identifier (e.g., conversation associated with a thread and/or a root object), and/or the like, can be stored in association with the virtual space.

In various examples, the messaging component 116 can receive a message transmitted in association with a virtual space (e.g., direct message instance, communication channel, canvas, collaborative document, etc.). In various examples, the messaging component 116 can identify one or more users associated with the virtual space and can cause a rendering of the message in association with instances of the virtual space on respective user computing devices 104. In various examples, the messaging component 116 can identify the message as an update to the virtual space and, based on the identified update, can cause a notification associated with the update to be presented in association with a sidebar of user interface associated with one or more of the user(s) associated with the virtual space. For example, the messaging component 116 can receive, from a first user account, a message transmitted in association with a virtual space. In response to receiving the message (e.g., interaction data associated with an interaction of a first user with the virtual space), the messaging component 116 can identify a second user associated with the virtual space (e.g., another user that is a member of the virtual space). In some examples, the messaging component 116 can cause a notification of an update to the virtual space to be presented via a sidebar of a user interface associated with a second user account of the second user. In some examples, the messaging component 116 can cause the notification to be presented in response to a determination that the sidebar of the user interface associated with the second user account includes an affordance associated with the virtual space. In such examples, the notification can be presented in association with the affordance associated with the virtual space.

In various examples, the messaging component 116 can be configured to identify a mention or tag associated with the message transmitted in association with the virtual space. In at least one example, the mention or tag can include an @mention (or other special character) of a user identifier that is associated with the communication platform. The user identifier can include a username, real name, or other unique identifier that is associated with a particular user. In response to identifying the mention or tag of the user identifier, the messaging component 116 can cause a notification to be presented on a user interface associated with the user identifier, such as in association with an affordance associated with the virtual space in a sidebar of a user interface associated with the particular user and/or in a virtual space associated with mentions and reactions. That is, the messaging component 116 can be configured to alert a particular user that they were mentioned in a virtual space.

In at least one example, the audio/video component 118 can be configured to manage audio and/or video communications between and among users. In some examples, the audio and/or video communications can be associated with an audio and/or video conversation. In at least one example, the audio and/or video conversation can include a discrete identifier configured to uniquely identify the audio and/or video conversation. In some examples, the audio and/or video component 118 can store user identifiers associated with user accounts of members of a particular audio and/or video conversation, such as to identify user(s) with appropriate permissions to access the particular audio and/or video conversation.

In some examples, communications associated with an audio and/or video conversation (“conversation”) can be synchronous and/or asynchronous. That is, the conversation can include a real-time audio and/or video conversation between a first user and a second user during a period of time and, after the first period of time, a third user who is associated with (e.g., is a member of) the conversation can contribute to the conversation. The audio/video component 118 can be configured to store audio and/or video data associated with the conversation, such as to enable users with appropriate permissions to listen and/or view the audio and/or video data.

In some examples, the audio/video component 118 can be configured to generate a transcript of the conversation, and can store the transcript in association with the audio and/or video data. The transcript can include a textual representation of the audio and/or video data. In at least one example, the audio/video component 118 can use known speech recognition techniques to generate the transcript. In some examples, the audio/video component 118 can generate the transcript concurrently or substantially concurrently with the conversation. That is, in some examples, the audio/video component 118 can be configured to generate a textual representation of the conversation while it is being conducted. In some examples, the audio/video component 118 can generate the transcript after receiving an indication that the conversation is complete. The indication that the conversation is complete can include an indication that a host or administrator associated therewith has stopped the conversation, that a threshold number of meeting attendees have closed associated interfaces, and/or the like. That is, the audio/video component 118 can identify a completion of the conversation and, based on the completion, can generate the transcript associated therewith.

In at least one example, the audio/video component 118 can be configured to cause presentation of the transcript in association with a virtual space with which the audio and/or video conversation is associated. For example, a first user can initiate an audio and/or video conversation in association with a communication channel. The audio/video component 118 can process audio and/or video data between attendees of the audio and/or video conversation, and can generate a transcript of the audio and/or video data. In response to generating the transcript, the audio/video component 118 can cause the transcript to be published or otherwise presented via the communication channel. In at least one example, the audio/video component 118 can render one or more sections of the transcript selectable for commenting, such as to enable members of the communication channel to comment on, or further contribute to, the conversation. In some examples, the audio/video component 118 can update the transcript based on the comments.

In at least one example, the audio/video component 118 can manage one or more audio and/or video conversations in association with a virtual space associated with a group (e.g., organization, team, etc.) administrative or command center. The group administrative or command center can be referred to herein as a virtual (and/or digital) headquarters associated with the group. In at least one example, the audio/video component 118 can be configured to coordinate with the messaging component 116 and/or other components of the server(s) 102, to transmit communications in association with other virtual spaces that are associated with the virtual headquarters. That is, the messaging component 116 can transmit data (e.g., messages, images, drawings, files, etc.) associated with one or more communication channels, direct messaging instances, collaborative documents, canvases, and/or the like, that are associated with the virtual headquarters. In some examples, the communication channel(s), direct messaging instance(s), collaborative document(s), canvas(es), and/or the like can have associated therewith one or more audio and/or video conversations managed by the audio/video component 118. That is, the audio and/or video conversations associated with the virtual headquarters can be further associated with, or independent of, one or more other virtual spaces of the virtual headquarters.

In at least one example, the representation component 120 may be configured to determine one or more frequent channels and/or one or more related users using machine-learning model(s) 130. That is, in at least one example, machine-learning model(s) 130 associated with the representation component 120 may be configured to receive user interaction data (e.g., channels, posts, relationships, documents, and/or other interaction data including how many messages a user sends to another user, how recently a user sent a message to a user, how often a user reads messages in a channel, how often a user reacts to posts in a channel, how often a user replies to posts in a channel, etc.) and output one or more frequent channels a user is active in and/or one or more related users a user communicates with actively. The representation component 120 may then associate the one or more frequent channels and/or one or more related users with profile data of a user account. In some examples, the representation component 120 may receive a request from a user, via a user computing device 104, to generate a representative list of channels the user may be associated with and/or a representative list of users the user frequently interacts with. In some examples, user may manually edit (e.g., add, remove, rearrange, highlight, etc.) the one or more of the representative channels/or users associated with the user account (e.g., on a profile page associated with the user).

The representation component 120 may utilize machine-learning model(s) 130 that accept inputs, and using the inputs, output first data representing one or more channels and second data representing one or more users associated with the with the group-based communication platform. The first data and the second data may be stored in datastore 124. In some examples, the input data may be data relating to a user's interactions with the user's own profile (e.g., information a user adds to the user's profile including work information, affiliations, interests, favorite channels, etc.), a user's interactions with other channels of the group-based communication platform (e.g., a user's reactions, messages, emojis, etc.), and/or a user's interactions with other users (e.g., conversation data from the group-based communication platform including messages, emojis, user identifiers, user actions (“like” or “dislikes”), charts, videos, and/or other forms of interaction data. Inputs may also include text data, documents, images, video(s), transcripts of the audio/video, or other forms of interaction data relating to user interactions with the group-based communication platform.

In some examples, the machine-learning model(s) 130 may be configured receive third-party data (e.g., interaction data between a user and a third-party provider). For example, the machine-learning model(s) 130 may receive, as input, third party data such as an external contact lists maintained by a third-party service provide, calendar(s) maintained by a third party application, documents, files, photos, messages, emails, or the like.

The machine-learning model(s) 130 may be trained to generate one or more representative channels a user account is most active in. For example, the machine-learning model(s) 130 may detect a frequency of communications by the user(s) in channels, past feedback, communications in a channel (or other interactions of the users in a channel) exceeding a threshold level, documents posted in a channel, communications of the user being marked as favorite in a channel, an assignment of tasks to users in a channel, a rating of one or more channels, an area of expertise of the user, user preferences, user specified information on the user's profile, user specified permissions, heuristics from user activities, and/or other interactions of the user with channels. The machine-learning model(s) 130 may also be trained to identify the respective messages, contributions, posts, and the like for the user(s) within the group-based communication platform.

The machine-learning model(s) 130 may be trained to generate data representing one or more users a user account interacts with regularly. For example, the machine-learning model(s) 130 may detect a frequency of communications between users (private and/or public communications), communications between users in a channel (or other interactions of the users in a channel) that exceed a threshold level, a number of documents shared between users, an assignment of tasks between users, an area of expertise of the users, user preferences, user specified information on the user's profile (e.g., interests, background information, related people, etc.), user specified permissions, common work hours (e.g., users that work similar days, hours, shifts, etc.), heuristics from user activities, and/or other interactions between the users.

In some examples, the machine-learning model(s) 130 may be trained from training data that represents previous representative channels and/or users using supervised and/or unsupervised approaches. In some examples, the machine-learning model(s) 130 may include Generative Pre-trained Transformer 3 (GPT-3) model, a neural model for summarization, such as an abstractive or a generative summarization model, natural language processing, machine learning, and/or other techniques that identify meaning and/or sentiment in messages within the group-based communication platform. In some examples, these techniques are configured to receive various forms of inputs for generating the representative channels and/or users.

In some examples, the representation component 120 can manage the frequent channels and/or related users section(s) of a user profile. That is, the representation component 120 can select and display channels and/or users on a profile page based on the output of the machine-learning model(s) 130. For example, the representation component 120 may receive one or more channels and respective confidence levels as output from the machine-learning model(s) 130. In some examples, the representation component 120 may select a single channel from the one or more representative channels. For example, the representation component 120 may compare the confidence levels of the respective channels and select the channel with the highest confidence level (i.e., the channel that is most likely associated with the user account). Based on selecting the channel with the highest confidence level, the representation component 120 may determine whether the confidence level of the selected channel meets or exceeds a threshold confidence level. In some examples, a user may increase or decrease the confidence level based on any number of factors considered to be more or less important to the user (e.g., how often the user reads messages in a channel, how often a user reacts to posts in a channel, how often a user replies to posts in a channel, user profile data, etc.). Based on determining that the confidence level associated with a channel meets or exceeds the threshold confidence level, the representation component 120 may associate the channel with a user profile.

The representation component 120 may receive one or more users (or user accounts) and respective confidence levels as output from the machine-learning model(s) 130. In some examples, the representation component 120 may select a single user from one or more representative users to associate with a user profile. For example, the representation component 120 may compare the confidence levels of the respective users and select a user with the highest confidence level (i.e., a second user account that is most likely interacting with the first user account). Based on selecting the user with the highest confidence level, the representation component 120 may determine whether the confidence level of the selected user meets or exceeds a threshold confidence level. In some examples, a user may increase or decrease the confidence level based on any number of factors considered to be more or less important to the user (e.g., how often the user sends messages to the other user, a length of the messages sent to the other user, how often the user reacts to another user's posts, how often the user replies to the other user's posts, how many channels the users share, etc.). Based on determining that the confidence level associated with a representative user meets or exceeds the threshold confidence level, the representation component 120 may associate the user with a user profile. For example, the representation component 120 may add the second user to a list of “frequent users” associated with the first user's profile page.

In some examples, the representation component 120 can update (i.e., add, remove, or rearrange) the representative channels and/or representative users associated with a user account and can integrate such updated data into user interface(s) presented via user computing device(s) of users associated with the group-based communication platform. In some examples, the representation component 120 can update one or more representative channels and/or one or more representative users section(s) of a user's profile based at least in part on passage of time (e.g., a day, week, month, etc.), receiving a threshold number of interaction data (i.e., detecting the user has interacted with a threshold number of new users), or based on a user's request to update the user's profile information.

In some examples, the representation component 120 may present different representative channels and/or representative users associated with a user account depending on who is viewing a user's profile. In some examples, the communication platform can analyze messaging and other interaction data between users to determine relationship between users and infer organizational networks between users. Additional details of operations that can be performed by the representation component 120 are described below and throughout this disclosure.

In some examples, the communication platform can manage communication channels. In some examples, the communication platform can be a channel-based messaging platform, that in some examples, can be usable by group(s) of users. Users of the communication platform can communicate with other users via communication channels. A communication channel, or virtual space, can be a data route used for exchanging data between and among systems and devices associated with the communication platform. In some examples, a channel can be a virtual space where people can post messages, documents, and/or files. In some examples, access to channels can be controlled by permissions. In some examples, channels can be limited to a single organization, shared between different organizations, public, private, or special channels (e.g., hosted channels with guest accounts where guests can make posts but are prevented from performing certain actions, such as inviting other users to the channel). In some examples, some users can be invited to channels via email, channel invites, direct messages, text messages, and the like. Examples of channels and associated functionality are discussed throughout this disclosure.

In at least one example, the operating system 122 can manage the processor(s) 132, computer-readable media 110, hardware, software, etc. of the server(s) 102.

In at least one example, the datastore 124 can be configured to store data that is accessible, manageable, and updatable. In some examples, the datastore 124 can be integrated with the server(s) 102, as shown in FIG. 1. In other examples, the datastore 124 can be located remotely from the server(s) 102 and can be accessible to the server(s) 102 and/or user device(s), such as the user device 104. The datastore 124 can comprise multiple databases, which can include user/org data 126 and/or virtual space data 128. Additional or alternative data may be stored in the data store and/or one or more other data stores.

In at least one example, the user/org data 126 can include data associated with users of the communication platform. In at least one example, the user/org data 126 can store data in user profiles (which can also be referred to as “user accounts”), which can store data associated with a user, including, but not limited to, one or more user identifiers associated with multiple, different organizations or entities with which the user is associated, one or more communication channel identifiers associated with communication channels to which the user has been granted access, one or more group identifiers for groups (or, organizations, teams, entities, or the like) with which the user is associated, an indication whether the user is an owner or manager of any communication channels, an indication whether the user has any communication channel restrictions, a plurality of messages, a plurality of emojis, a plurality of conversations, a plurality of conversation topics, an avatar, an email address, a real name (e.g., John Doe), a username (e.g., j doe), a password, a time zone, a status, a token, and the like.

In at least one example, the user/org data 126 can include permission data associated with permissions of individual users of the communication platform. In some examples, permissions can be set automatically or by an administrator of the communication platform, an employer, enterprise, organization, or other entity that utilizes the communication platform, a team leader, a group leader, or other entity that utilizes the communication platform for communicating with team members, group members, or the like, an individual user, or the like. Permissions associated with an individual user can be mapped to, or otherwise associated with, an account or profile within the user/org data 126. In some examples, permissions can indicate which users can communicate directly with other users, which channels a user is permitted to access, restrictions on individual channels, which workspaces the user is permitted to access, restrictions on individual workspaces, and the like. In at least one example, the permissions can support the communication platform by maintaining security for limiting access to a defined group of users. In some examples, such users can be defined by common access credentials, group identifiers, or the like, as described above.

In at least one example, the user/org data 126 can include data associated with one or more organizations of the communication platform. In at least one example, the user/org data 126 can store data in organization profiles, which can store data associated with an organization, including, but not limited to, one or more user identifiers associated with the organization, one or more virtual space identifiers associated with the organization (e.g., workspace identifiers, communication channel identifiers, direct message instance identifiers, collaborative document identifiers, canvas identifiers, audio/video conversation identifiers, etc.), an organization identifier associated with the organization, one or more organization identifiers associated with other organizations that are authorized for communication with the organization, and the like.

In at least one example, the virtual space data 128 can include data associated with one or more virtual spaces associated with the communication platform. The virtual space data 128 can include textual data, audio data, video data, images, files, and/or any other type of data configured to be transmitted in association with a virtual space. Non-limiting examples of virtual spaces include workspaces, communication channels, direct messaging instances, collaborative documents, canvases, and audio and/or video conversations. In at least one example, the virtual space data can store data associated with individual virtual spaces separately, such as based on a discrete identifier associated with each virtual space. In some examples, a first virtual space can be associated with a second virtual space. In such examples, first virtual space data associated with the first virtual space can be stored in association with the second virtual space. For example, data associated with a collaborative document that is generated in association with a communication channel may be stored in association with the communication channel. For another example, data associated with an audio and/or video conversation that is conducted in association with a communication channel can be stored in association with the communication channel.

As discussed above, each virtual space of the communication platform can be assigned a discrete identifier that uniquely identifies the virtual space. In some examples, the virtual space identifier associated with the virtual space can include a physical address in the virtual space data 128 where data related to that virtual space is stored. A virtual space may be “public,” which may allow any user within an organization (e.g., associated with an organization identifier) to join and participate in the data sharing through the virtual space, or a virtual space may be “private,” which may restrict data communications in the virtual space to certain users or users having appropriate permissions to view. In some examples, a virtual space may be “shared,” which may allow users associated with different organizations (e.g., entities associated with different organization identifiers) to join and participate in the data sharing through the virtual space. Shared virtual spaces (e.g., shared channels) may be public such that they are accessible to any user of either organization, or they may be private such that they are restricted to access by certain users (e.g., users with appropriate permissions) of both organizations.

In some examples, the datastore 124 can be partitioned into discrete items of data that may be accessed and managed individually (e.g., data shards). Data shards can simplify many technical tasks, such as data retention, unfurling (e.g., detecting that message contents include a link, crawling the link's metadata, and determining a uniform summary of the metadata), and integration settings. In some examples, data shards can be associated with organizations, groups (e.g., workspaces), communication channels, users, or the like.

In some examples, individual organizations can be associated with a database shard within the datastore 124 that stores data related to a particular organization identification. For example, a database shard may store electronic communication data associated with members of a particular organization, which enables members of that particular organization to communicate and exchange data with other members of the same organization in real time or near-real time. In this example, the organization itself can be the owner of the database shard and has control over where and how the related data is stored. In some examples, a database shard can store data related to two or more organizations (e.g., as in a shared virtual space).

In some examples, individual groups can be associated with a database shard within the datastore 124 that stores data related to a particular group identification (e.g., workspace). For example, a database shard may store electronic communication data associated with members of a particular group, which enables members of that particular group to communicate and exchange data with other members of the same group in real time or near-real time. In this example, the group itself can be the owner of the database shard and has control over where and how the related data is stored.

In some examples, a virtual space can be associated with a database shard within the datastore 124 that stores data related to a particular virtual space identification. For example, a database shard may store electronic communication data associated with the virtual space, which enables members of that particular virtual space to communicate and exchange data with other members of the same virtual space in real time or near-real time. As discussed above, the communications via the virtual space can be synchronous and/or asynchronous. In at least one example, a group or organization can be the owner of the database shard and can control where and how the related data is stored.

In some examples, individual users can be associated with a database shard within the datastore 124 that stores data related to a particular user account. For example, a database shard may store electronic communication data associated with an individual user, which enables the user to communicate and exchange data with other users of the communication platform in real time or near-real time. In some examples, the user itself can be the owner of the database shard and has control over where and how the related data is stored.

In some examples, such as when a channel is shared between two organizations, each organization can be associated with its own encryption key. When a user associated with one organization posts a message or file to the shared channel it can be encrypted in the datastore 124 with the encryption key specific to the organization and the other organization can decrypt the message or file prior to accessing the message or file. Further, in examples where organizations are in different geographical areas, data associated with a particular organization can be stored in a location corresponding to the organization and temporarily cached at a location closer to a client (e.g., associated with the other organization) when such messages or files are to be accessed. Data can be maintained, stored, and/or deleted in the datastore 124 in accordance with a data governance policy associated with each specific organization.

The communication interface(s) 112 can include one or more interfaces and hardware components for enabling communication with various other devices (e.g., the user computing device 104), such as over the network(s) 106 or directly. In some examples, the communication interface(s) 112 can facilitate communication via WebSockets, Application Programming Interfaces (APIs) (e.g., using API calls), Hypertext Transfer Protocols (HTTPS), etc.

The server(s) 102 can further be equipped with various input/output devices 114 (e.g., I/O devices). Such I/O devices 114 can include a display, various user interface controls (e.g., buttons, joystick, keyboard, mouse, touch screen, etc.), audio speakers, connection ports and so forth.

In at least one example, the user computing device 104 can include one or more processors 132 computer-readable media 134, one or more communication interfaces 136, and input/output devices 138.

In at least one example, each processor of the processor(s) 132 can be a single processing unit or multiple processing units, and can include single or multiple computing units or multiple processing cores. The processor(s) 132 can comprise any of the types of processors described above with reference to the processor(s) 132 and may be the same as or different than the processor(s) 132.

The computer-readable media 134 can comprise any of the types of computer-readable media 134 described above with reference to the computer-readable media 110 and may be the same as or different than the computer-readable media 110. Functional components stored in the computer-readable media can optionally include at least one application 138 and an operating system 140.

In at least one example, the application 140 can be a mobile application, a web application, or a desktop application, which can be provided by the communication platform or which can be an otherwise dedicated application. In some examples, individual user computing devices associated with the environment 100 can have an instance or versioned instance of the application 140, which can be downloaded from an application store, accessible via the Internet, or otherwise executable by the processor(s) 132 to perform operations as described herein. That is, the application 140 can be an access point, enabling the user computing device 104 to interact with the server(s) 102 to access and/or use communication services available via the communication platform. In at least one example, the application 138 can facilitate the exchange of data between and among various other user computing devices, for example via the server(s) 102. In at least one example, the application 140 can present user interfaces, as described herein. In at least one example, a user can interact with the user interfaces via touch input, keyboard input, mouse input, spoken input, or any other type of input.

A non-limiting example of a user interface 144 is shown in FIG. 1. As illustrated in FIG. 1, the user interface 144 can present data associated with one or more virtual spaces, which may include one or more workspaces. That is, in some examples, the user interface 144 can integrate data from multiple workspaces into a single user interface so that the user (e.g., of the user computing device 104) can access and/or interact with data associated with the multiple workspaces that he or she is associated with and/or otherwise communicate with other users associated with the multiple workspaces. In some examples, the user interface 144 can include a first region 146, or pane, that includes indicator(s) (e.g., user interface element(s) or object(s)) associated with workspace(s) with which the user (e.g., account of the user) is associated. In some examples, the user interface 144 can include a second region 148, or pane, that includes indicator(s) (e.g., user interface element(s), affordance(s), object(s), etc.) representing data associated with the workspace(s) with which the user (e.g., account of the user) is associated. In at least one example, the second region 148 can represent a sidebar of the user interface 144.

In at least one example, the user interface 144 can include a third region 150, or pane, that can be associated with a data feed (or, “feed”) indicating messages posted to and/or actions taken with respect to one or more communication channels and/or other virtual spaces for facilitating communications (e.g., a virtual space associated with direct message communication(s), a virtual space associated with event(s) and/or action(s), etc.) as described herein. In at least one example, data associated with the third region 150 can be associated with the same or different workspaces. That is, in some examples, the third region 150 can present data associated with the same or different workspaces via an integrated feed. In some examples, the data can be organized and/or is sortable by workspace, time (e.g., when associated data is posted or an associated operation is otherwise performed), type of action, communication channel, user, or the like. In some examples, such data can be associated with an indication of which user (e.g., member of the communication channel) posted the message and/or performed an action. In examples where the third region 150 presents data associated with multiple workspaces, at least some data can be associated with an indication of which workspace the data is associated with. In some examples, the third region 150 may be resized or popped out as a standalone window.

In at least one example, the operating system 142 can manage the processor(s) 132, computer-readable media 134, hardware, software, etc. of the server(s) 102.

The communication interface(s) 136 can include one or more interfaces and hardware components for enabling communication with various other devices (e.g., the user computing device 104), such as over the network(s) 106 or directly. In some examples, the communication interface(s) 136 can facilitate communication via WebSockets, APIs (e.g., using API calls), HTTPs, etc.

The user computing device 104 can further be equipped with various input/output devices 138 (e.g., I/O devices). Such I/O devices 138 can include a display, various user interface controls (e.g., buttons, joystick, keyboard, mouse, touch screen, etc.), audio speakers, connection ports and so forth.

While techniques described herein are described as being performed by the messaging component 116, the audio/video component 118, representation component 120, and the application 138, techniques described herein can be performed by any other component, or combination of components, which can be associated with the server(s) 102, the user computing device 104, or a combination thereof.

### User Interface for a Group-Based Communication System

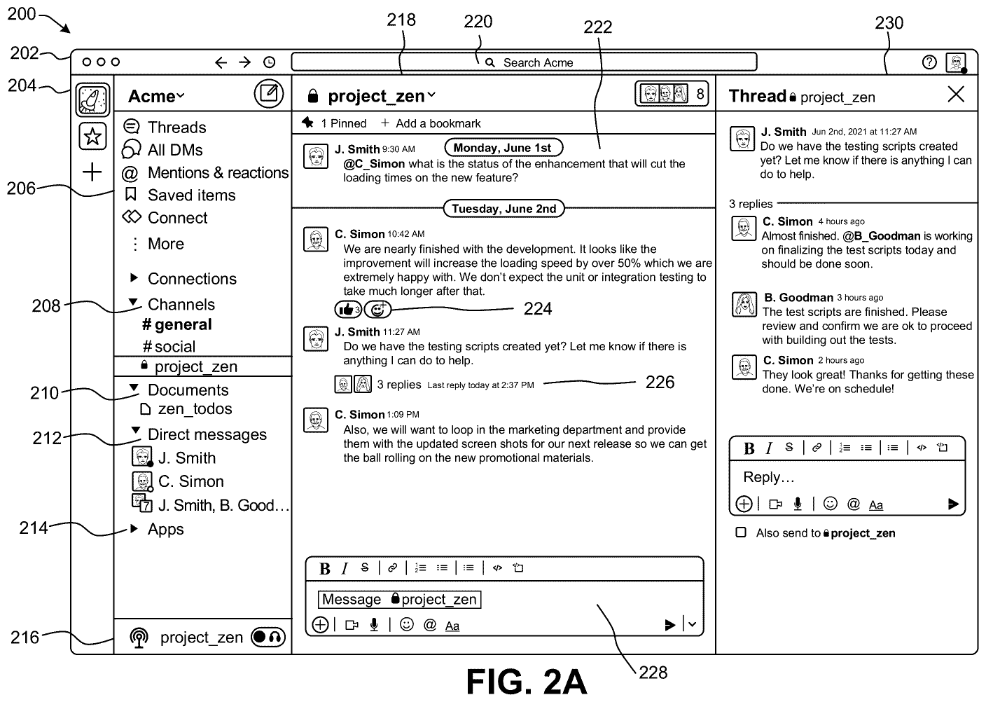

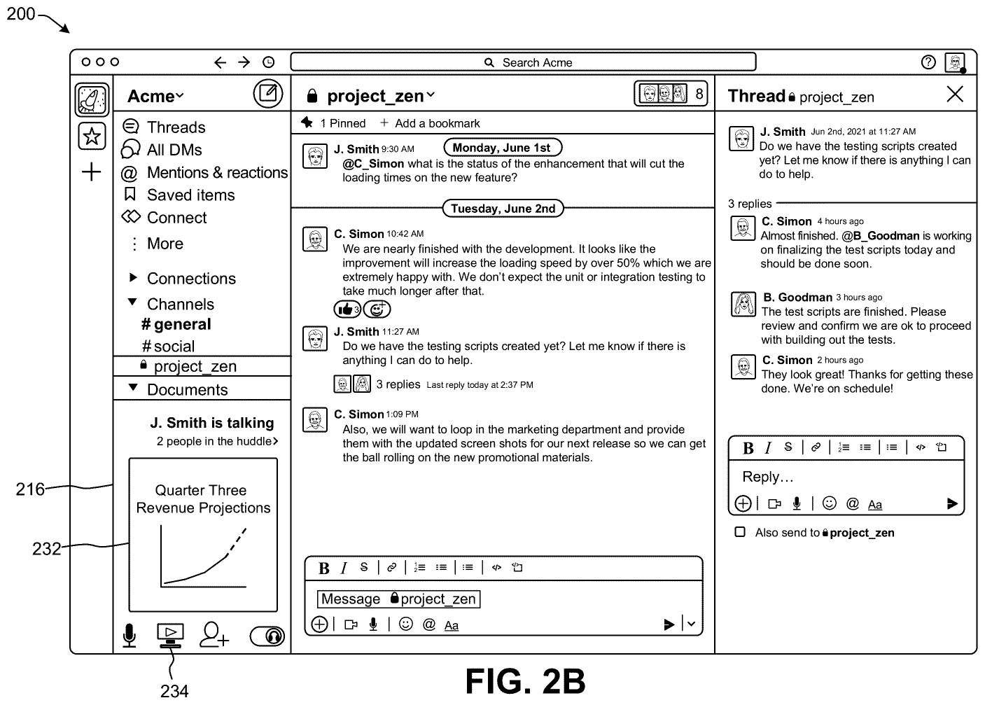

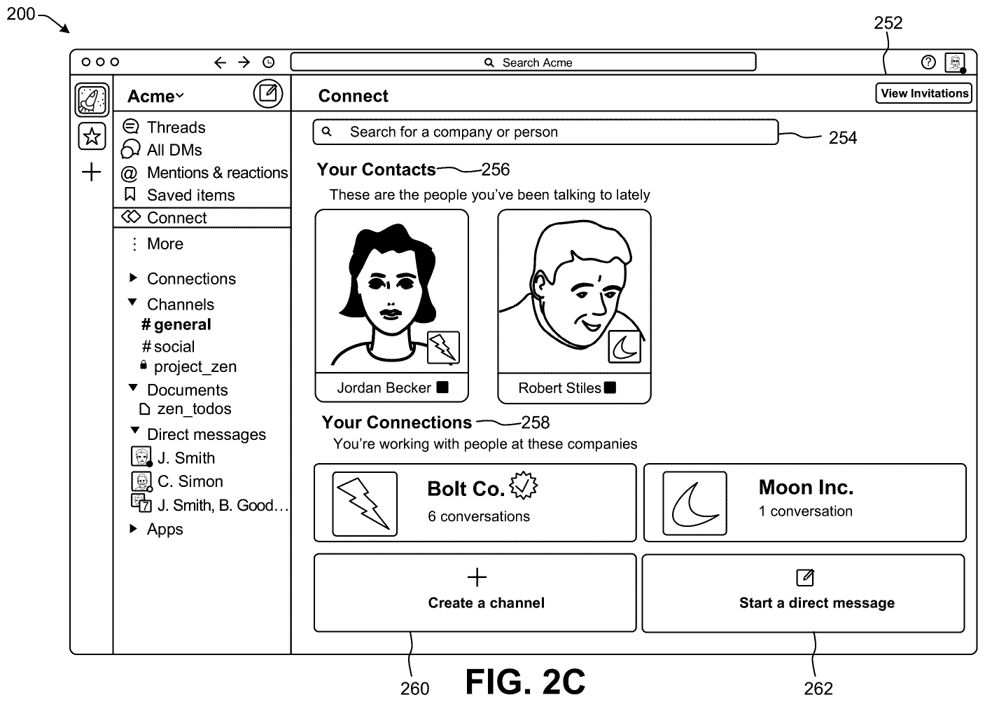

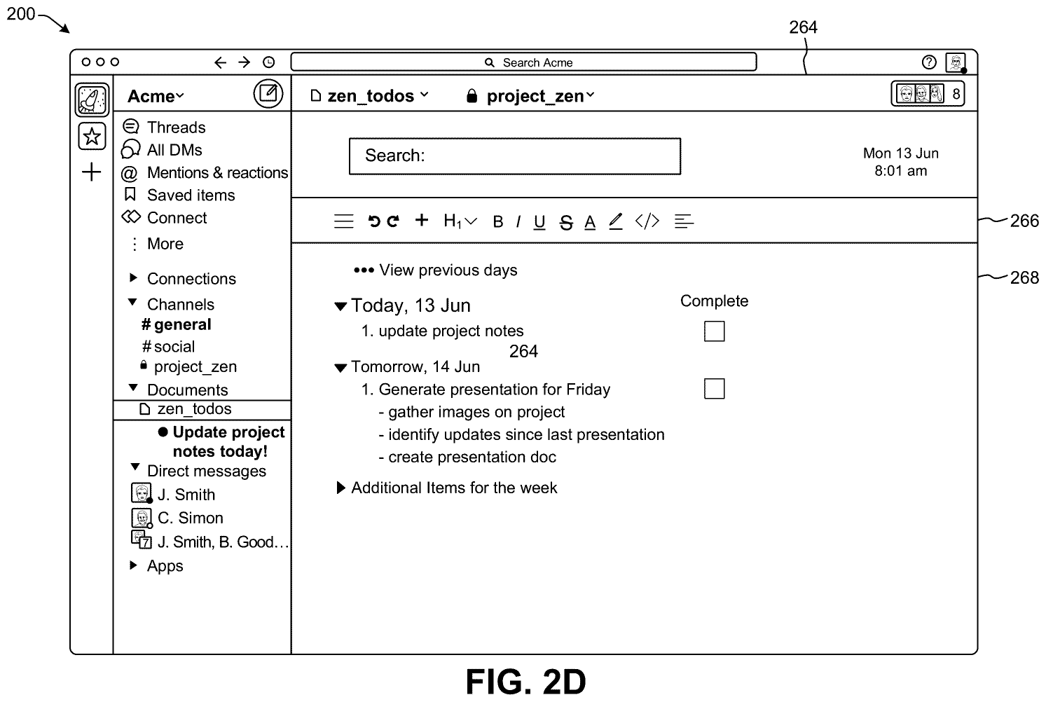

FIG. 2A illustrates a user interface 200 of a group-based communication system, which will be useful in illustrating the operation of various examples discussed herein. The group-based communication system may include communication data such as messages, queries, files, mentions, users or user profiles, interactions, tickets, channels, applications integrated into one or more channels, conversations, workspaces, or other data generated by or shared between users of the group-based communication system. In some instances, the communication data may comprise data associated with a user, such as a user identifier, channels to which the user has been granted access, groups with which the user is associated, permissions, and other user-specific information.

The user interface 200 comprises a plurality of objects such as panes, text entry fields, buttons, messages, or other user interface components that are viewable by a user of the group-based communication system. As depicted, the user interface 200 comprises a title bar 202, a workspace pane 204, a navigation pane 206, channels 208, documents 210 (e.g., collaborative documents), direct messages 212, applications 214, a synchronous multimedia collaboration session pane 216, and channel pane 218.

By way of example and without limitation, when a user opens the user interface 200 they can select a workspace via the workspace pane 204. A particular workspace may be associated with data specific to the workspace and accessible via permissions associated with the workspace. Different sections of the navigation pane 206 can present different data and/or options to a user. Different graphical indicators may be associated with virtual spaces (e.g., channels) to summarize an attribute of the channel (e.g., whether the channel is public, private, shared between organizations, locked, etc.). When a user selects a channel, a channel pane 218 may be presented. In some examples, the channel pane 218 can include a header, pinned items (e.g., documents or other virtual spaces), an “about” document providing an overview of the channel, and the like. In some cases, members of a channel can search within the channel, access content associated with the channel, add other members, post content, and the like. In some examples, depending on the permissions associated with a channel, users who are not members of the channel may have limited ability to interact with (or even view or otherwise access) a channel. As users navigate within a channel they can view messages 222 and may react to messages (e.g., a reaction 224), reply in a thread, start threads, and the like. Further, a channel pane 218 can include a compose pane 228 to compose message(s) and/or other data to associate with a channel. In some examples, the user interface 200 can include a threads pane 230 that provides additional levels of detail of the messages 222. In some examples, different panes can be resized, panes can be popped out to independent windows, and/or independent windows can be merged to multiple panes of the user interface 200. In some examples, users may communicate with other users via a collaboration pane 216, which may provide synchronous or asynchronous voice and/or video capabilities for communication. Of course, these are illustrative examples and additional examples of the aforementioned features are provided throughout this disclosure.

In some examples, title bar 202 comprises search bar 220. The search bar 220 may allow users to search for content located in the current workspace of the group-based communication system, such as files, messages, channels, members, commands, functions, and the like. Users may refine their searches by attributes such as content type, content author, and by users associated with the content. Users may optionally search within specific workspaces, channels, direct message conversations, or documents. In some examples, the title bar 202 comprises navigation commands allowing a user to move backwards and forwards between different panes, as well as to view a history of accessed content. In some examples, the title bar 202 may comprise additional resources such as links to help documents and user configuration settings.

In some examples, the group-based communication system can comprise a plurality of distinct workspaces, where each workspace is associated with different groups of users and channels. Each workspace can be associated with a group identifier and one or more user identifiers can be mapped to, or otherwise associated with, the group identifier. Users corresponding to such user identifiers may be referred to as members of the group. In some examples, the user interface 200 comprises the workspace pane 204 for navigating between, adding, or deleting various workspaces in the group-based communication system. For example, a user may be a part of a workspace for Acme, where the user is an employee of or otherwise affiliated with Acme. The user may also be a member of a local volunteer organization that also uses the group-based communication system to collaborate. To navigate between the two groups, the user may use the workspace pane 204 to change from the Acme workspace to the volunteer organization workspace. A workspace may comprise one or more channels that are unique to that workspace and/or one or more channels that are shared between one or more workspaces. For example, the Acme company may have a workspace for Acme projects, such as Project Zen, a workspace for social discussions, and an additional workspace for general company matters. In some examples, an organization, such as a particular company, may have a plurality of workspaces, and the user may be associated with one or more workspaces belonging to the organization. In yet other examples, a particular workspace can be associated with one or more organizations or other entities associated with the group-based communication system.

In some examples, the navigation pane 206 permits users to navigate between virtual spaces such as pages, channels 208, collaborative documents 210 (such as those discussed at FIG. 2D), applications 214, and direct messages 212 within the group-based communication system. For example, the navigation pane 206 can include indicators representing virtual spaces that can aggregate data associated with a plurality of virtual spaces of which the user is a member. In at least one example, each virtual space can be associated with an indicator in the navigation pane 206. In some examples, an indicator can be associated with an actuation mechanism (e.g., an affordance, also referred to as a graphical element) such that when actuated, can cause the user interface 200 to present data associated with the corresponding virtual space. In at least one example, a virtual space can be associated with all unread data associated with each of the workspaces with which the user is associated. That is, in some examples, if the user requests to access the virtual space associated with “unreads,” all data that has not been read (e.g., viewed) by the user can be presented, for example in a feed. In such examples, different types of events and/or actions, which can be associated with different virtual spaces, can be presented via the same feed. In some examples, such data can be organized and/or is sortable by associated virtual space (e.g., virtual space via which the communication was transmitted), time, type of action, user, and/or the like. In some examples, such data can be associated with an indication of which user (e.g., member of the associated virtual space) posted the message and/or performed an action.

In some examples, a virtual space can be associated with the same type of event and/or action. For example, “threads” can be associated with messages, files, etc. posted in threads to messages posted in a virtual space and “mentions and reactions” can be associated with messages or threads where the user has been mentioned (e.g., via a tag) or another user has reacted (e.g., via an emoji, reaction, or the like) to a message or thread posted by the user. That is, in some examples, the same types of events and/or actions, which can be associated with different virtual spaces, can be presented via the same feed. As with the “unreads” virtual space, data associated with such virtual spaces can be organized and/or is sortable by virtual space, time, type of action, user, and/or the like.

In some examples, a virtual space can be associated with facilitating communications between a user and other users of the communication platform. For example, “connect” can be associated with enabling the user to generate invitations to communicate with one or more other users. In at least one example, responsive to receiving an indication of selection of the “connect” indicator, the communication platform can cause a connections interface to be presented.

In some examples, a virtual space can be associated with one or more boards or collaborative documents with which the user is associated. In at least one example, a document can include a collaborative document configured to be accessed and/or edited by two or more users with appropriate permissions (e.g., viewing permissions, editing permissions, etc.). In at least one example, if the user requests to access the virtual space associated with one or more documents with which the user is associated, the one or more documents can be presented via the user interface 200. In at least one example, the documents, as described herein, can be associated with an individual (e.g., private document for a user), a group of users (e.g., collaborative document), and/or one or more communication channels (e.g., members of the communication channel rendered access permissions to the document), such as to enable users of the communication platform to create, interact with, and/or view data associated with such documents. In some examples, the collaborative document can be a virtual space, a board, a canvas, a page, or the like for collaborative communication and/or data organization within the communication platform. In at least one example, the collaborative document can support editable text and/or objects that can be ordered, added, deleted, modified, and/or the like. In some examples, the collaborative document can be associated with permissions defining which users of a communication platform can view and/or edit the document. In some examples, a collaborative document can be associated with a communication channel, and members of the communication channel can view and/or edit the document. In some examples, a collaborative document can be sharable such that data associated with the document is accessible to and/or interactable for members of the multiple communication channels, workspaces, organizations, and/or the like.

In some examples, a virtual space can be associated with a group (e.g., organization, team, etc.) headquarters (e.g., administrative or command center). In at least one example, the group headquarters can include a virtual or digital headquarters for administrative or command functions associated with a group of users. For example, “HQ” can be associated with an interface including a list of indicators associated with virtual spaces configured to enable associated members to communicate. In at least one example, the user can associate one or more virtual spaces with the “HQ” virtual space, such as via a drag and drop operation. That is, the user can determine relevant virtual space(s) to associate with the virtual or digital headquarters, such as to associate virtual space(s) that are important to the user therewith.

In some examples, a virtual space can be associated with one or more boards or collaborative documents with which the user is associated. In at least one example, a document can include a collaborative document configured to be accessed and/or edited by two or more users with appropriate permissions (e.g., viewing permissions, editing permissions, etc.). In at least one example, if the user requests to access the virtual space associated with one or more documents with which the user is associated, the one or more documents can be presented via the user interface 200. In at least one example, the documents, as described herein, can be associated with an individual (e.g., private document for a user), a group of users (e.g., collaborative document), and/or one or more communication channels (e.g., members of the communication channel rendered access permissions to the document), such as to enable users of the communication platform to create, interact with, and/or view data associated with such documents. In some examples, the collaborative document can be a virtual space, a board, a canvas, a page, or the like for collaborative communication and/or data organization within the communication platform. In at least one example, the collaborative document can support editable text and/or objects that can be ordered, added, deleted, modified, and/or the like. In some examples, the collaborative document can be associated with permissions defining which users of a communication platform can view and/or edit the document. In some examples, a collaborative document can be associated with a communication channel, and members of the communication channel can view and/or edit the document. In some examples, a collaborative document can be sharable such that data associated with the document is accessible to and/or interactable for members of the multiple communication channels, workspaces, organizations, and/or the like.

Additionally or in the alternative, in some examples, a virtual space can be associated with one or more canvases with which the user is associated. In at least one example, the canvas can include a flexible canvas for curating, organizing, and sharing collections of information between users. That is, the canvas can be configured to be accessed and/or modified by two or more users with appropriate permissions. In at least one example, the canvas can be configured to enable sharing of text, images, videos, GIFs, drawings (e.g., user-generated drawing via a canvas interface), gaming content (e.g., users manipulating gaming controls synchronously or asynchronously), and/or the like. In at least one example, modifications to a canvas can include adding, deleting, and/or modifying previously shared (e.g., transmitted, presented) data. In some examples, content associated with a canvas can be shareable via another virtual space, such that data associated with the canvas is accessible to and/or rendered interactable for members of the virtual space.

The navigation pane 206 may further comprise indicators representing communication channels (e.g., the channels 208). In some examples, the communication channels can include public channels, private channels, shared channels (e.g., between groups or organizations), single workspace channels, cross-workspace channels, combinations of the foregoing, or the like. In some examples, the communication channels represented can be associated with a single workspace. In some examples, the communication channels represented can be associated with different workspaces (e.g., cross-workspace). In at least one example, if a communication channel is cross-workspace (e.g., associated with different workspaces), the user may be associated with both workspaces, or may only be associated with one of the workspaces. In some examples, the communication channels represented can be associated with combinations of communication channels associated with a single workspace and communication channels associated with different workspaces.

In some examples, the navigation pane 206 may depict some or all of the communication channels that the user has permission to access (e.g., as determined by the permission data). In such examples, the communication channels can be arranged alphabetically, based on most recent interaction, based on frequency of interactions, based on communication channel type (e.g., public, private, shared, cross-workspace, etc.), based on workspace, in user-designated sections, or the like. In some examples, the navigation pane 206 can depict some or all of the communication channels that the user is a member of, and the user can interact with the user interface 200 to browse or view other communication channels that the user is not a member of but are not currently displayed in the navigation pane 206. In some examples, different types of communication channels (e.g., public, private, shared, cross-workspace, etc.) can be in different sections of the navigation pane 206, or can have their own sub-regions or sub-panes in the user interface 200. In some examples, communication channels associated with different workspaces can be in different sections of the navigation pane 206, or can have their own regions or panes in the user interface 200.

In some examples, the indicators can be associated with graphical elements that visually differentiate types of communication channels. For example, project_zen is associated with a lock graphical element. As a non-limiting example, and for the purpose of this discussion, the lock graphical element can indicate that the associated communication channel, project_zen, is private and access thereto is limited, whereas another communication channel, general, is public and access thereto is available to any member of an organization with which the user is associated. In some examples, additional or alternative graphical elements can be used to differentiate between shared communication channels, communication channels associated with different workspaces, communication channels with which the user is or is not a current member, and/or the like.

In at least one example, the navigation pane 206 can include indicators representative of communications with individual users or multiple specified users (e.g., instead of all, or a subset of, members of an organization). Such communications can be referred to as “direct messages.” The navigation pane 206 can include indicators representative of virtual spaces that are associated with private messages between one or more users.

The direct messages 212 may be communications between a first user and a second user, or they may be multi-person direct messages between a first user and two or more second users. The navigation pane 206 may be sorted and organized into hierarchies or sections depending on the user's preferences. In some examples, all of the channels to which a user has been granted access may appear in the navigation pane 206. In other examples, the user may choose to hide certain channels or collapse sections containing certain channels. Items in the navigation pane 206 may indicate when a new message or update has been received or is currently unread, such as by bolding the text associated with a channel in which an unread message is located or adding an icon or badge (for example, with a count of unread messages) to the channel name. In some examples, the group-based communication system may additionally or alternatively store permissions data associated with permissions of individual users of the group-based communication system, indicating which channels a user may view or join. Permissions can indicate, for example, which users can communicate directly with other users, which channels a user is permitted to access, restrictions on individual channels, which workspaces the user is permitted to access, and restrictions on individual workspaces.

Additionally or in the alternative, the navigation pane 206 can include a sub-section that is a personalized sub-section associated with a team of which the user is a member. That is, the “team” sub-section can include affordance(s) of one or more virtual spaces that are associated with the team, such as communication channels, collaborative documents, direct messaging instances, audio or video synchronous or asynchronous meetings, and/or the like. In at least one example, the user can associate selected virtual spaces with the team sub-section, such as by dragging and dropping, pinning, or otherwise associating selected virtual spaces with the team sub-section.

Channels within the Group-Based Communication System

In some examples, the group-based communication system is a channel-based messaging platform, as shown in FIG. 2A. Within the group-based communication system, communication may be organized into channels, each dedicated to a particular topic and a set of users. Channels are generally a virtual space relating to a particular topic comprising messages and files posted by members of the channel.

For purposes of this discussion, a “message” can refer to any electronically generated digital object provided by a user using the user computing device 104 and that is configured for display within a communication channel and/or other virtual space for facilitating communications (e.g., a virtual space associated with direct message communication(s), etc.) as described herein. A message may include any text, image, video, audio, or combination thereof provided by a user (using a user computing device). For instance, the user may provide a message that includes text, as well as an image and a video, within the message as message contents. In such an example, the text, image, and video would comprise the message. Each message sent or posted to a communication channel of the communication platform can include metadata comprising a sending user identifier, a message identifier, message contents, a group identifier, a communication channel identifier, or the like. In at least one example, each of the foregoing identifiers may comprise American Standard Code for Information Interchange (ASCII) text, a pointer, a memory address, or the like.

The channel discussion may persist for days, months, or years and provide a historical log of user activity. Members of a particular channel can post messages within that channel that are visible to other members of that channel together with other messages in that channel. Users may select a channel for viewing to see only those messages relevant to the topic of that channel without seeing messages posted in other channels on different topics. For example, a software development company may have different channels for each software product being developed, where developers working on each particular project can converse on a generally singular topic (e.g., project) without noise from unrelated topics. Because the channels are generally persistent and directed to a particular topic or group, users can quickly and easily refer to previous communications for reference. In some examples, the channel pane 218 may display information related to a channel that a user has selected in the navigation pane 206. For example, a user may select the project_zen channel to discuss the ongoing software development efforts for Project Zen. In some examples, the channel pane 218 may include a header comprising information about the channel, such as the channel name, the list of users in the channel, and other channel controls. Users may be able to pin items to the header for later access and add bookmarks to the header. In some examples, links to collaborative documents may be included in the header. In further examples, each channel may have a corresponding virtual space which includes channel-related information such as a channel summary, tasks, bookmarks, pinned documents, and other channel-related links which may be editable by members of the channel.

A communication channel or other virtual space can be associated with data and/or content other than messages, or data and/or content that is associated with messages. For example, non-limiting examples of additional data that can be presented via the channel pane 218 of the user interface 200 include collaborative documents (e.g., documents that can be edited collaboratively, in real-time or near real-time, etc.), audio and/or video data associated with a conversation, members added to and/or removed from the communication channel, file(s) (e.g., file attachment(s)) uploaded and/or removed from the communication channel), application(s) added to and/or removed from the communication channel, post(s) (data that can be edited collaboratively, in near real-time by one or members of a communication channel) added to and/or removed from the communication channel, description added to, modified, and/or removed from the communication channel, modifications of properties of the communication channel, etc.

The channel pane 218 may include messages such as message 222, which is content posted by a user into the channel. Users may post text, images, videos, audio, or any other file as the message 222. In some examples, particular identifiers (in messages or otherwise) may be denoted by prefixing them with predetermined characters. For example, channels may be prefixed by the “#” character (as in #project_zen) and username may be prefixed by the “@” character (as in @J_Smith or @User_A). Messages such as the message 222 may include an indication of which user posted the message and the time at which the message was posted. In some examples, users may react to messages by selecting a reaction button 224. The reaction button 224 allows users to select an icon (sometimes called a reacji in this context), such as a thumbs up, to be associated with the message. Users may respond to messages, such as the message 222, of another user with a new message. In some examples, such conversations in channels may further be broken out into threads. Threads may be used to aggregate messages related to a particular conversation together to make the conversation easier to follow and reply to, without cluttering the main channel with the discussion. Under the message beginning the thread appears a thread reply preview 226. The thread reply preview 226 may show information related to the thread, such as, for example, the number of replies and the members who have replied. Thread replies may appear in a thread pane 230 that may be separate from the channel pane 218 and may be viewed by other members of the channel by selecting the thread reply preview 226 in the channel pane 218.

In some examples, one or both of the channel pane 218 and the thread pane 230 may include a compose pane 228. In some examples, the compose pane 228 allows users to compose and transmit messages 222 to the members of the channel or to those members of the channel who are following the thread (when the message is sent in a thread). The compose pane 228 may have text editing functions such as bold, strikethrough, and italicize, and/or may allow users to format their messages or attach files such as collaborative documents, images, videos, or any other files to share with other members of the channel. In some examples, the compose pane 228 may enable additional formatting options such as numbered or bulleted lists via either the user interface or an API. The compose pane 228 may also function as a workflow trigger to initiate workflows related to a channel or message. In further examples, links or documents sent via the compose pane 228 may include unfurl instructions related to how the content should be displayed.

### Synchronous Multimedia Collaboration Sessions

FIG. 2B illustrates a multimedia collaboration session (e.g., a synchronous multimedia collaboration session) that has been triggered from a channel, as shown in pane 216. Synchronous multimedia collaboration sessions may provide ambient, ad hoc multimedia collaboration in the group-based communication system. Users of the group-based communication system can quickly and easily join and leave these synchronous multimedia collaboration sessions at any time, without disrupting the synchronous multimedia collaboration session for other users. In some examples, synchronous multimedia collaboration sessions may be based around a particular topic, a particular channel, a particular direct message or multi-person direct message, or a set of users, while in other examples, synchronous multimedia collaboration sessions may exist without being tied to any channel, topic, or set of users.

Synchronous multimedia collaboration session pane 216 may be associated with a session conducted for a plurality of users in a channel, users in a multi-person direct message conversation, or users in a direct message conversation. Thus, a synchronous multimedia collaboration session may be started for a particular channel, multi-person direct message conversation, or direct message conversation by one or more members of that channel or conversation. Users may start a synchronous multimedia collaboration session in a channel as a means of communicating with other members of that channel who are presently online. For example, a user may have an urgent decision and want immediate verbal feedback from other members of the channel. As another example, a synchronous multimedia collaboration session may be initiated with one or more other users of the group-based communication system through direct messaging. In some examples, the audience of a synchronous multimedia collaboration session may be determined based on the context in which the synchronous multimedia collaboration session was initiated. For example, starting a synchronous multimedia collaboration session in a channel may automatically invite the entire channel to attend. As another example. Starting a synchronous multimedia collaboration session allows the user to start an immediate audio and/or video conversation with other members of the channel without requiring scheduling or initiating a communication session through a third-party interface. In some examples, users may be directly invited to attend a synchronous multimedia collaboration session via a message or notification.

Synchronous multimedia collaboration sessions may be short, ephemeral sessions from which no data is persisted. Alternatively, in some examples, synchronous multimedia collaboration sessions may be recorded, transcribed, and/or summarized for later review. In other examples, contents of the synchronous multimedia collaboration session may automatically be persisted in a channel associated with the synchronous multimedia collaboration session. Members of a particular synchronous multimedia collaboration session can post messages within a messaging thread associated with that synchronous multimedia collaboration session that are visible to other members of that synchronous multimedia collaboration session together with other messages in that thread.

The multimedia in a synchronous multimedia collaboration session may include collaboration tools such as any or all of audio, video, screen sharing, collaborative document editing, whiteboarding, co-programming, or any other form of media. Synchronous multimedia collaboration sessions may also permit a user to share the user's screen with other members of the synchronous multimedia collaboration session. In some examples, members of the synchronous multimedia collaboration session may mark-up, comment on, draw on, or otherwise annotate a shared screen. In further examples, such annotations may be saved and persisted after the synchronous multimedia collaboration session has ended. A canvas may be created directly from a synchronous multimedia collaboration session to further enhance the collaboration between users.

In some examples, a user may start a synchronous multimedia collaboration session via a toggle in synchronous multimedia collaboration session pane 216 shown in FIG. 2B. Once a synchronous multimedia collaboration session has been started, synchronous multimedia collaboration session pane 216 may be expanded to provide information about the synchronous multimedia collaboration session such as how many members are present, which user is currently talking, which user is sharing the user's screen, and/or screen share preview 232. In some examples, users in the synchronous multimedia collaboration session may be displayed with an icon indicating that they are participating in the synchronous multimedia collaboration session. In further examples, an expanded view of the participants may show which users are active in the synchronous multimedia collaboration session and which are not. Screen share preview 232 may depict the desktop view of a user sharing the user's screen, or a particular application or presentation. Changes to the user's screen, such as the user advancing to the next slide in a presentation, will automatically be depicted in screen share preview 232. In some examples, the screen share preview 232 may be actuated to cause the screen share preview 232 to be enlarged such that it is displayed as its own pane within the group-based communication system. In some examples, the screen share preview 232 can be actuated to cause the screen share preview 232 to pop out into a new window or application separate and distinct from the group-based communication system. In some examples, the synchronous multimedia collaboration session pane 216 may comprise tools for the synchronous multimedia collaboration session allowing a user to mute the user's microphone or invite other users. In some examples, the synchronous multimedia collaboration session pane 216 may comprise a screen share button 234 that may permit a user to share the user's screen with other members of the synchronous multimedia collaboration session pane 216. In some examples, the screen share button 234 may provide a user with additional controls during a screen share. For example, a user sharing the user's screen may be provided with additional screen share controls to specify which screen to share, to annotate the shared screen, or to save the shared screen.

In some cases, the synchronous multimedia collaboration session pane 216 may persist in the navigation pane 206 regardless of the state of the group-based communication system. In some examples, when no synchronous multimedia collaboration session is active and/or depending on which item is selected from the navigation pane 206, the synchronous multimedia collaboration session pane 216 may be hidden or removed from being presented via the user interface 200. In some instances, when the pane 216 is active, the pane 216 can be associated with a currently selected channel, direct message, or multi-person direct message such that a synchronous multimedia collaboration session may be initiated and associated with the currently selected channel, direct message, or multi-person direct message.

A list of synchronous multimedia collaboration sessions may include one or more active synchronous multimedia collaboration sessions selected for recommendation. For example, the synchronous multimedia collaboration sessions may be selected from a plurality of currently active synchronous multimedia collaboration sessions. Further, the synchronous multimedia collaboration sessions may be selected based in part on user interaction with the sessions or some association of the instant user with the sessions or users involved in the sessions. For example, the recommended synchronous multimedia collaboration sessions may be displayed based in part on the instant user having been invited to a respective synchronous multimedia collaboration session or having previously collaborated with the users in the recommended synchronous multimedia collaboration session. In some examples, the list of synchronous multimedia collaboration sessions further includes additional information for each respective synchronous multimedia collaboration session, such as an indication of the participating users or number of participating users, a topic for the synchronous multimedia collaboration session, and/or an indication of an associated group-based communication channel, multi-person direct message conversation, or direct message conversation.

In some examples, a list of recommended active users may include a plurality of group-based communication system users recommended based on at least one of user activity, user interaction, or other user information. For example, the list of recommended active users may be selected based on an active status of the users within the group-based communication system; historic, recent, or frequent user interaction with the instant user (such as communicating within the group-based communication channel); or similarity between the recommended users and the instant user (such as determining that a recommended user shares common membership in channels with the instant user). In some examples, machine learning techniques such as cluster analysis can be used to determine recommended users. The list of recommended active users may include status user information for each recommended user, such as whether the recommended user is active, in a meeting, idle, in a synchronous multimedia collaboration session, or offline. In some examples, the list of recommended active users further comprises a plurality of actuatable buttons corresponding to some of or all the recommended users (for example, those recommended users with a status indicating availability) that, when selected, may be configured to initiate at least one of a text-based communication session (such as a direct message conversation) or a synchronous multimedia collaboration session.

In some examples, one or more recommended asynchronous multimedia collaboration sessions or meetings can be displayed in an asynchronous meeting section. By contrast with a synchronous multimedia collaboration session (described above), an asynchronous multimedia collaboration session allows each participant to collaborate at a time convenient to them. This collaboration participation is then recorded for later consumption by other participants, who can generate additional multimedia replies. In some examples, the replies are aggregated in a multimedia thread (for example, a video thread) corresponding to the asynchronous multimedia collaboration session. For example, an asynchronous multimedia collaboration session may be used for an asynchronous meeting where a topic is posted in a message at the beginning of a meeting thread and participants of the meeting may reply by posting a message or a video response. The resulting thread then comprises any documents, video, or other files related to the asynchronous meeting. In some examples, a preview of a subset of video replies may be shown in the asynchronous collaboration session or thread. This can allow, for example, a user to jump to a relevant segment of the asynchronous multimedia collaboration session or to pick up where they left off previously.

Connecting within the Group-Based Communication System

FIG. 2C illustrates user interface 200 displaying a connect pane 252. The connect pane 252 may provide tools and resources for users to connect across different organizations, where each organization may have their own (normally private) instance of the group-based communication system or may not yet belong to the group-based communication system. For example, a first software company may have a joint venture with a second software company with whom they wish to collaborate on jointly developing a new software application. The connect pane 252 may enable users to determine which other users and organizations are already within the group-based communication system, and to invite those users and organizations currently outside of the group-based communication system to join.

The connect pane 252 may comprise a connect search bar 254, recent contacts 256, connections 258, a create channel button 260, and/or a start direct message button 262. In some examples, the connect search bar 254 may permit a user to search for users within the group-based communication system. In some examples, only users from organizations that have connected with the user's organization will be shown in the search results. In other examples, users from any organization that uses the group-based communication system can be displayed. In still other examples, users from organizations that do not yet use the group-based communication can also be displayed, allowing the searching user to invite them to join the group-based communication system. In some examples, users can be searched for via their group-based communication system username or their email address. In some examples, email addresses may be suggested or autocompleted based on external sources of data such as email directories or the searching user's contact list.

In some examples, external organizations as well as individual users may be shown in response to a user search. External organizations may be matched based on an organization name or internet domain, as search results may include organizations that have not yet joined the group-based communication system (similar to searching and matching for a particular user, discussed above). External organizations may be ranked based in part on how many users from the user's organization have connected with users of the external organization. Responsive to a selection of an external organization in a search result, the searching user may be able to invite the external organization to connect via the group-based communication system.

In some examples, the recent contacts 256 may display users with whom the instant user has recently interacted. The recent contacts 256 may display the user's name, company, and/or a status indication. The recent contacts 256 may be ordered based on which contacts the instant user most frequently interacts with or based on the contacts with whom the instant user most recently interacted. In some examples each recent contact of the recent contacts 256 may be an actuatable control allowing the instant user to quickly start a direct message conversation with the recent contact, invite them to a channel, or take any other appropriate user action for that recent contact.

In some examples, the connections 258 may display a list of companies (e.g., organizations) with which the user has interacted. For each company, the name of the company may be displayed along with the company's logo and an indication of how many interactions the user has had with the company, for example the number of conversations. In some examples, each connection of the connections 258 may be an actuatable control allowing the instant user to quickly invite the external organization to a shared channel, display recent connections with that external organization, or take any other appropriate organization action for that connection.

In some examples, the create channel button 260 allows a user to create a new shared channel between two different organizations. Selecting the create channel button 260 may further allow a user to name the new connect channel and enter a description for the connect channel. In some examples, the user may select one or more external organizations or one or more external users to add to the shared channel. In other examples, the user may add external organizations or external users to the shared channel after the shared channel is created. In some examples, the user may elect whether to make the connect channel private (e.g., accessible only by invitation from a current member of the private channel).

In some examples, the start direct message button 262 allows a user to quickly start a direct message (or multi-person direct message) with external users at an external organization. In some examples, the external user identifier at an external organization may be supplied by the instant user as the external user's group-based communication system username or as the external user's email address. In some examples, an analysis of the email domain of the external user's email address may affect the message between the user and the external user. For example, the external user's identifier may indicate (for example, based on an email address domain) that the user's organization and the external user's organization are already connected. In some such examples, the email address may be converted to a group-based communication system username.

Alternatively, the external user's identifier may indicate that the external user's organization belongs to the group-based communication system but is not connected to the instant user's organization. In some such examples, an invitation to connect to the instant user's organization may be generated in response. As another alternative, the external user may not be a member of the group-based communication system, and an invitation to join the group-based communication system as a guest or a member may be generated in response.

### Collaborative Documents

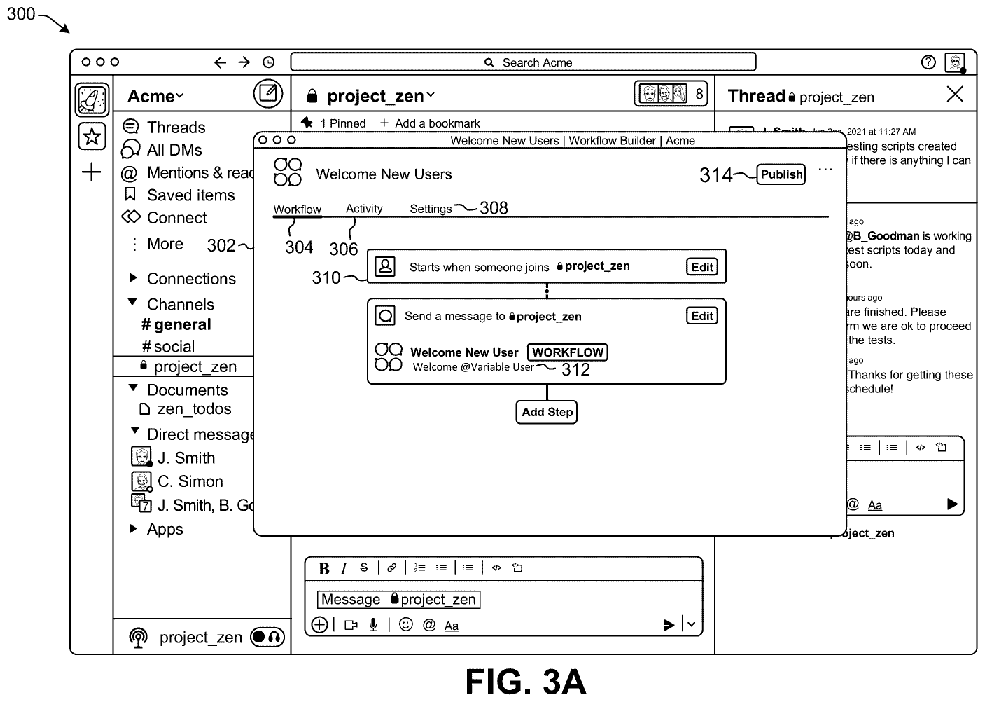

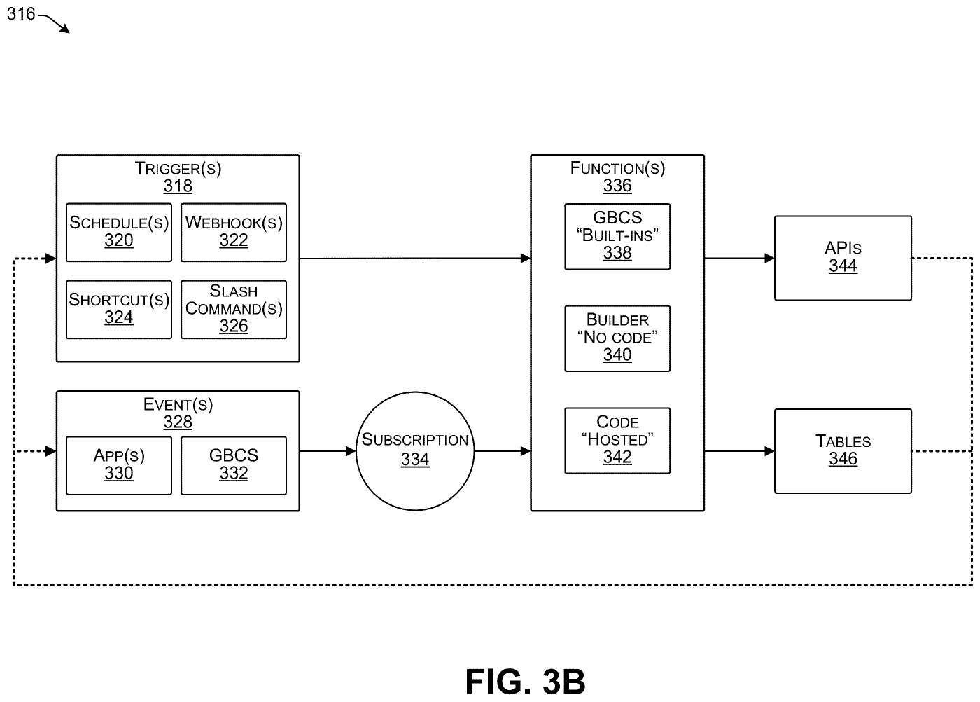

FIG. 2D illustrates user interface 200 displaying a collaboration document pane 264. A collaborative document may be any file type, such as a PDF, video, audio, word processing document, etc., and is not limited to a word processing document or a spreadsheet. A collaborative document may be modified and edited by two or more users. A collaborative document may also be associated with different user permissions, such that based on a user's permissions for the document (or sections of the document as discussed below), the user may selectively be permitted to view, edit, or comment on the collaborative document (or sections of the collaborative document). As such, users within the set of users having access to the document may have varying permissions for viewing, editing, commenting, or otherwise interfacing with the collaborative document. In some examples, permissions can be determined and/or assigned automatically based on how document(s) are created and/or shared. In some examples, permission can be determined manually. Collaborative documents may allow users to simultaneously or asynchronously create and modify documents. Collaborative documents may integrate with the group-based communication system and can both initiate workflows and be used to store the results of workflows, which are discussed further below with respect to FIGS. 3A and 3B.

In some examples, the user interface 200 can comprise one or more collaborative documents (or one or more links to such collaborative documents). A collaborative document (also referred to as a document or canvas) can include a flexible workspace for curating, organizing, and sharing collections of information between users. Such documents may be associated with a synchronous multimedia collaboration session, an asynchronous multimedia collaboration session, a channel, a multi-person direct message conversation, and/or a direct message conversation. Shared canvases can be configured to be accessed and/or modified by two or more users with appropriate permissions. Alternatively or in addition, a user might have one or more private documents that are not associated with any other users.

Further, such documents can be @mentioned, such that particular documents can be referred to within channels (or other virtual spaces or documents) and/or other users can be @mentioned within such a document. For example, @mentioning a user within a document can provide an indication to that user and/or can provide access to the document to the user. In some examples, tasks can be assigned to a user via an @mention and such task(s) can be populated in the pane or sidebar associated with that user.

In some examples, a channel and a collaborative document 268 can be associated such that when a comment is posted in a channel it can be populated to a document 268, and vice versa.

In some examples, when a first user interacts with a collaborative document, the communication platform can identify a second user account associated with the collaborative document and present an affordance (e.g., a graphical element) in a sidebar (e.g., the navigation pane 206) indicative of the interaction. Further, the second user can select the affordance and/or a notification associated with or representing the interaction to access the collaborative document, to efficiently access the document and view the update thereto.

In some examples, as one or more users interact with a collaborative document, an indication (e.g., an icon or other user interface element) can be presented via user interfaces with the collaborative document to represent such interactions. For examples, if a first instance of the document is presently open on a first user computing device of a first user, and a second instance of the document is presently open on a second user computing device of a second user, one or more presence indicators can be presented on the respective user interfaces to illustrate various interactions with the document and by which user. In some examples, a presence indicator may have attributes (e.g., appearance attributes) that indicate information about a respective user, such as, but not limited to, a permission level (e.g., edit permissions, read-only access, etc.), virtual-space membership (e.g., whether the member belongs to a virtual space associated with the document), and the manner in which the user is interacting with the document (e.g., currently editing, viewing, open but not active, etc.).

In some examples, a preview of a collaborative document can be provided. In some examples, a preview can comprise a summary of the collaborative document and/or a dynamic preview that displays a variety of content (e.g., as changing text, images, etc.) to allow a user to quickly understand the context of a document. In some examples, a preview can be based on user profile data associated with the user viewing the preview (e.g., permissions associated with the user, content viewed, edited, created, etc. by the user), and the like.

In some examples, a collaborative document can be created independent of or in connection with a virtual space and/or a channel. A collaborative document can be posted in a channel and edited or interacted with as discussed herein, with various affordances or notifications indicating presence of users associated with documents and/or various interactions.

In some examples, a machine-learning model can be used to determine a summary of contents of a channel and can create a collaborative document comprising the summary for posting in the channel. In some examples, the communication platform may identify the users within the virtual space, actions associated with the users, and other contributions to the conversation to generate the summary document. As such, the communication platform can enable users to create a document (e.g., a collaborative document) for summarizing content and events that transpired within the virtual space.

In some examples, documents can be configured to enable sharing of content including (but not limited to) text, images, videos, GIFs, drawings (e.g., user-generated drawings via a drawing interface), or gaming content. In some examples, users accessing a canvas can add new content or delete (or modify) content previously added. In some examples, appropriate permissions may be required for a user to add content or to delete or modify content added by a different user. Thus, for example, some users may only be able to access some or all of a document in view-only mode, while other users may be able to access some or all of the document in an edit mode allowing those users to add or modify its contents. In some examples, a document can be shared via a message in a channel, multi-person direct message, or direct message, such that data associated with the document is accessible to and/or rendered interactable for members of the channel or recipients of the multi-person direct message or direct message.

In some examples, the collaboration document pane 264 may comprise collaborative document toolbar 266 and collaborative document 268. In some examples, collaborative document toolbar 266 may provide the ability to edit or format posts, as discussed herein.

In some examples, collaborative documents may comprise free-form unstructured sections and workflow-related structured sections. In some examples, unstructured sections may include areas of the document in which a user can freely modify the collaborative document without any constraints. For example, a user may be able to freely type text to explain the purpose of the document. In some examples, a user may add a workflow or a structured workflow section by typing the name of (or otherwise mentioning) the workflow. In further examples, typing the “at” sign (@), a previously selected symbol, or a predetermined special character or symbol may provide the user with a list of workflows the user can select to add to the document. For example, a user may indicate that a marketing team member needs to sign off on a proposal by typing “!Marketing Approval” to initiate a workflow that culminates in a member of the marketing team approving the proposal. Placement of an exclamation point prior to the group name of “Marketing Approval” initiates a request for a specification action, in this case routing the proposal for approval. In some examples, structured sections may include text entry, selection menus, tables, checkboxes, tasks, calendar events, or any other document section. In further examples, structured sections may include text entry spaces that are a part of a workflow. For example, a user may enter text into a text entry space detailing a reason for approval, and then select a submit button that will advance the workflow to the next step of the workflow. In some examples, the user may be able to add, edit, or remove structured sections of the document that make up the workflow components.

In examples, sections of the collaborative document may have individual permissions associated with them. For example, a collaborative document having sections with individual permissions may provide a first user permission to view, edit, or comment on a first section, while a second user does not have permission to view, edit, or comment on the first section. Alternatively, a first user may have permissions to view a first section of the collaborative document, while a second user has permissions to both view and edit the first section of the collaborative document. The permissions associated with a particular section of the document may be assigned by a first user via various methods, including manual selection of the particular section of the document by the first user or another user with permission to assign permissions, typing or selecting an “assignment” indicator, such as the “@” symbol, or selecting the section by a name of the section. In further examples, permissions can be assigned for a plurality of collaborative documents at a single instance via these methods. For example, a plurality of collaborative documents each has a section entitled “Group Information,” where the first user with permission to assign permissions desires an entire user group to have access to the information in the “Group Information” section of the plurality of collaborative documents. In examples, the first user can select the plurality of collaborative documents and the “Group Information” section to effectuate permissions to access (or view, edit, etc.) to the entire user group the “Group Information” section of each of the plurality of collaborative documents.

### Automation in the Group-Based Communication System

FIG. 3A illustrates user interface 300 for automation in the group-based communication system. Automation, also referred to as workflows, allow users to automate functionality within the group-based communication system. Workflow builder 302 is depicted which allows a user to create new workflows, modify existing workflows, and review the workflow activity. Workflow builder 302 may comprise a workflow tab 304, an activity tab 306, and/or a settings tab 308. In some examples, workflow builder may include a publish button 314 which permits a user to publish a new or modified workflow.

The workflow tab 304 may be selected to enable a user to create a new workflow or to modify an existing workflow. For example, a user may wish to create a workflow to automatically welcome new users who join a channel. A workflow may comprise workflow steps 310. Workflow steps 310 may comprise at least one trigger which initiates the workflow and at least one function which takes an action once the workflow is triggered. For example, a workflow may be triggered when a user joins a channel and a function of the workflow may be to post within the channel welcoming the new user. In some examples, workflows may be triggered from a user action, such as a user reacting to a message, joining a channel, or collaborating in a collaborative document, from a scheduled date and time, or from a web request from a third-party application or service. In further examples, workflow functionality may include sending messages or forms to users, channels, or any other virtual space, modifying collaborative documents, or interfacing with applications. Workflow functionality may include workflow variables 312. For example, a welcome message may include a user's name via a variable to allow for a customized message. Users may edit existing workflow steps or add new workflow steps depending on the desired workflow functionality. Once a workflow is complete, a user may publish the workflow using publish button 314. A published workflow will wait until it is triggered, at which point the functions will be executed.

Activity tab 306 may display information related to a workflow's activity. In some examples, the activity tab 306 may show how many times a workflow has been executed. In further examples, the activity tab 306 may include information related to each workflow execution including the status, last activity date, time of execution, user who initiated the workflow, and other relevant information. The activity tab 306 may permit a user to sort and filter the workflow activity to find useful information.

A settings tab 308 may permit a user to modify the settings of a workflow. In some examples, a user may change a title or an icon associated with the workflow. Users may also manage the collaborators associated with a workflow. For example, a user may add additional users to a workflow as collaborators such that the additional users can modify the workflow. In some examples, settings tab 308 may also permit a user to delete a workflow.

FIG. 3B depicts elements related to workflows in the group-based communication system and is referred to generally by reference numeral 316. In various examples, trigger(s) 318 can be configured to invoke execution of function(s) 336 responsive to user instructions. A trigger initiates function execution and may take the form of one or more schedule(s) 320, webhook(s) 322, shortcut(s) 324, and/or slash command(s) 326. In some examples, the schedule 320 operates like a timer so that a trigger may be scheduled to fire periodically or once at a predetermined point in the future. In some examples, an end user of an event-based application sets an arbitrary schedule for the firing of a trigger, such as once-an-hour or every day at 9:15 AM.

Additionally, triggers 318 may take the form of the webhook 322. The webhook 322 may be a software component that listens at a webhook URL and port. In some examples, a trigger fires when an appropriate HTTP request is received at the webhook URL and port. In some examples, the webhook 322 requires proper authentication such as by way of a bearer token. In other examples, triggering will be dependent on payload content.

Another source of one of the trigger(s) 318 is a shortcut in the shortcut(s) 324. In some examples, the shortcut(s) 324 may be global to a group-based communication system and are not specific to a group-based communication system channel or workspace. Global shortcuts may trigger functions that are able to execute without the context of a particular group-based communication system message or group-based communication channel. By contrast, message- or channel-based shortcuts are specific to a group-based communication system message or channel and operate in the context of the group-based communication system message or group-based communication channel.

A further source of one of triggers 318 may be provided by way of slash commands 326. In some examples, the slash command(s) 326 may serve as entry points for group-based communication system functions, integrations with external services, or group-based communication system message responses. In some examples, the slash commands 326 may be entered by a user of a group-based communication system to trigger execution of application functionality. Slash commands may be followed by slash-command-line parameters that may be passed along to any group-based communication system function that is invoked in connection with the triggering of a group-based communication system function such as one of functions 336.

An additional way in which a function is invoked is when an event (such as one of events 328) matches one or more conditions as predetermined in a subscription (such as subscription 334). Events 328 may be subscribed to by any number of subscriptions 334, and each subscription may specify different conditions and trigger a different function. In some examples, events are implemented as group-based communication system messages that are received in one or more group-based communication system channels. For example, all events may be posted as non-user visible messages in an associated channel, which is monitored by subscriptions 334. App events 330 may be group-based communication system messages with associated metadata that are created by an application in a group-based communication system channel. Events 328 may also be direct messages received by one or more group-based communication system users, which may be an actual user or a technical user, such as a bot. A bot is a technical user of a group-based communication system that is used to automate tasks. A bot may be controlled programmatically to perform various functions. A bot may monitor and help process group-based communication system channel activity as well as post messages in group-based communication system channels and react to members' in-channel activity. Bots may be able to post messages and upload files as well as be invited or removed from both public and private channels in a group-based communication system.

Events 328 may also be any event associated with a group-based communication system. Such group-based communication system events 332 include events relating to the creation, modification, or deletion of a user account in a group-based communication system or events relating to messages in a group-based communication system channel, such as creating a message, editing or deleting a message, or reacting to a message. Events 328 may also relate to creation, modification, or deletion of a group-based communication system channel or the membership of a channel. Events 328 may also relate to user profile modification or group creation, member maintenance, or group deletion.

As described above, subscription 334 indicates one or more conditions that, when matched by events, trigger a function. In some examples, a set of event subscriptions is maintained in connection with a group-based communication system such that when an event occurs, information regarding the event is matched against a set of subscriptions to determine which (if any) of functions 336 should be invoked. In some examples, the events to which a particular application may subscribe are governed by an authorization framework. In some instances, the event types matched against subscriptions are governed by OAuth permission scopes that may be maintained by an administrator of a particular group-based communication system.

In some examples, functions 336 can be triggered by triggers 318 and events 328 to which the function is subscribed. Functions 336 take zero or more inputs, perform processing (potentially including accessing external resources), and return zero or more results. Functions 336 may be implemented in various forms. First, there are group-based communication system built-ins 338, which are associated with the core functionality of a particular group-based communication system. Some examples include creating a group-based communication system user or channel. Second are no-code builder functions 340 that may be developed by a user of a group-based communication system user in connection with an automation user interface such as workflow builder user interface. Third, there are hosted-code functions 342 that are implemented by way of group-based communication system applications developed as software code in connection with a software development environment.

These various types of functions 336 may in turn integrate with APIs 344. In some examples, APIs 344 are associated with third-party services that functions 336 employ to provide a custom integration between a particular third-party service and a group-based communication system. Examples of third-party service integrations include video conferencing, sales, marketing, customer service, project management, and engineering application integration. In such an example, one of the triggers 318 would be a slash command 326 that is used to trigger a hosted-code function 342, which makes an API call to a third-party video conferencing provider by way of one of the APIs 344. As shown in FIG. 3B, the APIs 344 may themselves also become a source of any number of triggers 318 or events 328. Continuing the above example, successful completion of a video conference would trigger one of the functions 336 that sends a message initiating a further API call to the third-party video conference provider to download and archive a recording of the video conference and store it in a group-based communication system channel.

In addition to integrating with APIs 344, functions 336 may persist and access data in tables 346. In some examples, tables 346 are implemented in connection with a database environment associated with a serverless execution environment in which a particular event-based application is executing. In some instances, tables 346 may be provided in connection with a relational database environment. In other examples, tables 346 are provided in connection with a database mechanism that does not employ relational database techniques. As shown in FIG. 3B, in some examples, reading or writing certain data to one or more of tables 346, or data in table matching predefined conditions, is itself a source of some number of triggers 318 or events 328. For example, if tables 346 are used to maintain ticketing data in an incident-management system, then a count of open tickets exceeding a predetermined threshold may trigger a message being posted in an incident-management channel in the group-based communication system.

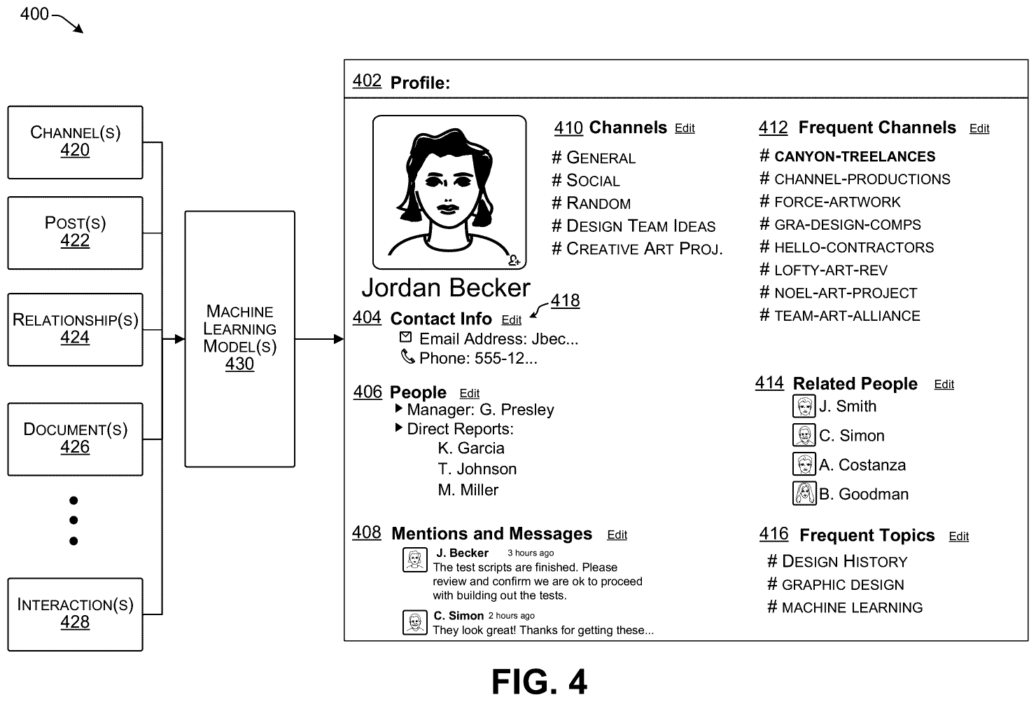

FIG. 4 illustrates an example user interface 400 associated with a communication platform, as described herein, for displaying a user profile including a frequent channels section, a related people section, and/or a frequent topics section.

Example user interface 400 may present information associated with a user account (e.g., “Jordan Becker” as indicated in user profile 402). As illustrated in FIG. 4, the user interface 400 may present data associated with one or more channels, people, documents, and/or in some examples, one or more workspaces. The example user interface 400 may include a section (e.g., which can be a portion, a pane, or other partitioned unit of the user interface 400) presenting contact information 404 associated with the user account. Contact information 404 may include, for example, one or more email addresses, phone numbers, a preferred contact method, social networking handle, addresses, occupation, organization, enterprise, etc. In some examples, a user profile 402 (which can also be referred to as “user account”) may include additional information or content such as a photo of the user, work hours, etc.

In some examples, a user account may store data associated with a user, including, but not limited to, one or more use identifiers associated with different organizations, groups, or entities with which the user is associated, one or more group identifiers for groups (or organizations, teams, entities, or the like) with which the user is associated, one or more channel identifiers associated with channels to which the user has granted, an indication whether the user is an owner or manager of any channels, an indication whether the user has any channel restrictions, one or more direct message identifiers associated with direct messages with which the user is associated, one or more document identifiers associated with collaborative and/or personal documents with which the user is associated, a plurality of message objects, a plurality of emojis, a plurality of conversations, a plurality of conversation topics, a time zone, work hours, a status, and the like.

In some examples, the example user interface 400 may include a section including users 406 or user accounts a user works with or reports to. For example, users 406 (or people) may include one or more managers, supervisors, team leaders, group leaders, direct report users, mentors, co-workers, HR members, and the like. In some examples, users 406 are associated with a role, title, or position within an organization or the communication platform. For example, as illustrated in FIG. 4, user G. Presley is associated with a manager title while K Garcia, T. Johnson, and M. Miller are associated with a “direct reports” role.

In some examples, the example user interface 400 may include a section to view mentions and messages 408 associated with the user account. As illustrated in FIG. 4, the mentions and messages 408 section may include one or more of recent messages sent to the user account, recent messages sent by the user account to another user, a recent reply to a post, a most recent mention of the user or user account in a channel, a favorited or highlighted message, etc. The type of information included in the mentions and messages 408 section may depend on a privacy setting associated with the user account, preferences of the user account, privacy setting associated with the message (e.g., whether the message was sent privately), a key word or phrase associated with a message, etc. When a user selects a message in the mentions and messages 408 section, a message pane may be presented. In some examples, the message pane may include access to content associated with the message, including the ability to respond to the message, to react to the message, to set a reminder to be associated with the message, to send the message to another user, and the like.

In some examples, the example user interface 400 may include any number of channels 410 which may be used to organize conversations between and amongst users according to topics. In some examples, the example user interface 400 may include channels 410 such as a general channel, a social channel, a random channel, help-tech channel, a help-onboarding channel, a design team ideas channel, creative art project channel, and/or any other channels associated with the user account. When a user selects a channel 410, a channel pane or window may be presented. In some examples, the channel pane may include access to content associated with the channel, in addition to enabling users to add other members, post content, and the like.

In some examples, the example user interface 400 may include any number of frequent channels 412 associated with the user account. Frequent channels 412 may include channels that the user account is active in (e.g., channels a user interacts with frequently) or channels the user manages. In some examples, frequent channels 412 may include channels that are most related to an area of expertise associated with a user. In some examples, frequent channels 412 may include channels that are not included in the channels 410 section of the user profile. In some examples, the frequent channels 412 section may be generated by (i.e., output by) a machine-learning model(s) 430 configured to receive user interaction data associated with channel(s) 420, post(s) 422, relationship(s) 424, document(s) 426, and/or interaction(s) 428 associated with the communication platform.

For example, machine-learning model(s) 430 may be configured to receive interaction data associated with channel(s) 420. Channel interaction data may include interactions a user takes in relation to a channel or virtual space associated with the communication platform. For example, channel interaction data may include user activity such as creating a channel (e.g., creating a channel suggests a higher degree of interest in the channel), adding one or more users to a channel, posting content (message, reaction, document, image, video, links to other documents, etc.) to a channel, responding to content in a channel within a period of time (e.g., responding to content posted in a channel within a shorter period of time suggests a higher degree of interest in the channel), interacting with the channel a threshold number of times within a period of time (e.g., viewing a channel 3 times in one day compared to viewing a channel once a week), a duration of time spent viewing content in a channel (e.g., leaving a channel open on a user computing device for a period of time), accessing and editing documents within a channel, and the like.

In some examples, machine-learning model(s) 430 may be configured to receive interaction data associated with post(s) 422. Post(s) 422 data can be associated with a data feed (or, “feed”) including messages posted to and/or actions taken with respect to one or more communication channels and/or other virtual spaces for facilitating communications. In some examples. Post(s) data may include creation of a post (e.g., which member of a channel created a post), editing a post, reacting to a post, a length of a post, a type of post (e.g., image, video, document link, etc.), and the like. Messages sent via the communication channel may also include metadata comprising a sending user identifier, a message identifier, message contents, a group identifier, a communication channel identifier, or the like, which can be input to machine-learning model(s) 430.

In some examples, machine-learning model(s) 430 may be configured to receive interaction data associated with relationship(s) 424 data. Relationship(s) 424 data broadly includes a user's set of direct and indirect interactions with another user as well as interactions with channels. For example, relationship(s) 424 data may include interactions between users or user accounts including, for example, how many messages from another user the user read, how quickly the messages were read (e.g., when a message was opened after receiving it) and/or responded to after the message was sent, how many messages of another user the user reacted to (e.g., using an emoji, or @mentioning the user or message), how many direct messages the user sent to another user, how many channels the user and another user have in common, a size of a channel the user and another user share (e.g., being active in a smaller channel signals a closer work relationship) and/or the like may be input into the machine-learning model(s) 430. In some examples, relationship(s) 424 data may include communications between users with certain roles, titles, positions, affiliations (e.g., CEO, CTO, supervisor, researcher, research assistant, etc.) within a communication platform.

Relationship(s) 424 interaction data may also include a user's relationship to one or more channels. For example, relationship data may include whether a user joined a channel (i.e., after receiving an invite), how many messages the user sent in the channel, how recently a user has been active in a channel, how many messages or posts the user read in a channel, how often the user checks updates in a channel, whether the user starred or favorited a channel, how similar a channel is to other channels the user participates in, and/or the like. In some examples, relationship(s) 424 data may include a user's relationship to a topic, keyword, or key phrase (e.g., a number of keywords or phrases used by individual users). For example, how many messages the user sent regarding a topic, how many messages the user read regarding the topic, how many reactions to the user's messages regarding the topic have been received, how many times files or documents regarding the topic have been attached to the user's messages and have been downloaded by other users, how many questions the user has asked about the topic, how many answers to questions the user has provided regarding the topic, or the like.

In some examples, machine-learning model(s) 430 may be configured to receive interaction data associated with document(s) 426. For example, data relating to document(s) 426 may include a title of a document, author(s) of a document, user(s) the document was shared with, channel(s) the document was posted in, user responses to a document posted in a channel, edits made to a document (e.g., types of edits, frequency of edits, etc.), content of a document (e.g., texts, symbols, emojis, drawings, images, videos, charts, lists, calendar ideas, spreadsheets, etc.) a topic of a document (including key words or phrases found within the document), a summary of a document, and/or the like. Machine-learning model(s) 430 may be configured to apply a certain weight to interaction data associated with certain documents or files. For example, interaction data associated with documents relating to certain topics (e.g., research projects, published articles, machine-learning, or artificial intelligence) may be given greater weight as compared to other documents. In some examples, the machine-learning model may compare documents within a channel, between a group of channels, between a group of users, an organization, and/or the communication platform, etc. In some examples, the weight that is applied to interaction data associated with document(s) 426 may vary depending on individual users, a certain role or title (e.g., CEO, CTO, supervisor, researcher, research assistant, etc.) associated with a user, and/or the types of interactions a user has with a document.

In some examples, machine-learning model(s) 430 may be configured to receive other interaction(s) 428 data associated with the communication platform. In some examples, machine-learning model(s) 430 may be configured to receive interaction data based on a permission setting associated with a user account, channel, message, document, etc. For example, machine-learning model(s) 430 may receive data associated with public interactions (e.g., data shared with more than one user such as in a group channel or group chat) while ignoring private interactions between one or more users, such as private messages sent between users. Interaction data may be considered “public” when users within an organization or channel may see, respond, react to, or otherwise participate in the sharing of the interaction data through a virtual space or channel. Interaction data may be “private” when it is associated with a restriction or restricts communications in a virtual space or channel to certain users or users having an appropriate permissions view only. In some examples, machine-learning models(s) 430 may, at least in part, may be trained to recognize and extract keywords or key phrases from private messages in order to help generate one or more representative channels, users, and/or topics to associate with a user account.

In some examples, machine-learning model(s) 430 may be configured to receive interaction data associated with third party applications or providers. Third party interaction data may include a user's interactions with an external contact list, calendars, messaging applications, emails or other information stored in association with a third-party service provider. In some examples, access to stored interaction data associated with third-party applications or providers may include sending a request to access particular interaction data.

In some examples, machine-learning model(s) 430 may generate data representing one or more representative channels based at least in part on user interaction data. Representative channels may include frequent channels a user interacts with or manages. In some examples, machine-learning model(s) 430 may be configured to output a confidence score associated with individual channels of the representative channels. The confidence score may indicate the degree to which an individual channel is likely to be associated with the user account. In some examples, the communication platform may determine an order for presenting the representative channels based at least in part on the confidence score. In some examples, the confidence score may be compared to a threshold score (e.g., above 50%, 60%, 90%, etc.) so that only channels with a confidence score above a threshold are associated with a user's profile data. In some examples, the communication platform may partition the representative channels into two or more sections based at least in part on the confidence score associated with individual channels. For example, the communication platform may have a first section including representative channels associated with a confidence score between 25% and 50%, a second section including representative channels associated with a confidence score between 51% and 80%, and a third section including representative channels associated with a confidence score between 81% and 100%. These confidence scores are only examples and any value may be used.

In some examples, the communication platform may enable a user to edit (e.g., using graphic identifier 418) or rearrange an order of the representative channels. The communication platform may then present, via the user interface associated with the group-based communication platform, the representative channels based on the selected order. In some examples, the communication platform may enable a user to highlight (e.g., increase the size of, change the color of, bolden, italicize, etc.), star (e.g., favorite), or otherwise emphasize (e.g., with an indicator) one or more representative channels according to a user's personal preferences. In some examples, channels a user has created may be associated with an indicator.

In some examples, a machine-learning model may generate data representing one or more frequent channels based at least in part on a number of frequent channels already associated with a user's profile data. For example, a user's profile may be associated with a maximum number of frequent channels (e.g., 3 channels, 5 channels, 20 channels, and the like). The maximum number of frequent channels that may be presented on a user's profile page may be set by the communication platform, an organization, an administrator, or a user. In some examples, user's profile may be associated with a minimum number of frequent channels. For example, a user may not have less than 3 frequent channels at any given time. A profile page associated with a maximum number of frequent channels may still be updated (e.g., automatically or by a user) over time to include new frequent channels. For example, the machine-learning model may recommend new frequent channels to the user based on new interaction data input into the machine-learning model over time. In some examples, the machine-learning model may update frequent channels associated with a profile page based on a user's request to modify the profile data, detecting a threshold number of keywords or key phrase associated with the user or user account, detecting the creation of a threshold number of channels, detecting a threshold number of new users accounts being added to the communication platform, detecting a threshold number of new employees being added to the user's organization, or a threshold period of time elapsing.

In some examples, the example user interface 400 may include any number of related people 414 (or related users) associated with a user account. Related people 414 may include other users or user accounts that the user account actively interacts or engages with. In some examples, related people 414 may include users that work on similar projects, share a general area of expertise, share a threshold number of channels, and/or users that may be interested in collaborating on a project. In some examples, the related people 414 section associated with a user account may be generated by (i.e., output by) a machine-learning model(s) 430 configured to receive user interaction data associated with channel(s) 420, post(s) 422, relationship(s) 424, document(s) 426, and/or interaction(s) 428 associated with the communication platform. In some examples, the machine-learning model that outputs one or more related people 414 (or representative users) is the same or different machine-learning model that outputs one or more representative channels.

In some examples, machine-learning model(s) 430 may be configured to output a confidence score associated with individual users of the representative users. The confidence score may indicate the degree to which an individual user is likely to be associated with the user account. In some examples, the communication platform may determine an order for presenting the representative users based at least in part on the confidence score. In some examples, the confidence score may be compared to a threshold score (e.g., above 50%, 60%, 90%, etc.) so that only users with a confidence score above a threshold are associated with a user's profile data. In some examples, the communication platform may partition the representative users into two or more sections based at least in part on the confidence score associated with individual users. For example, the communication platform may have a first section including representative users associated with a confidence score between 25% and 50%, a second section including representative users associated with a confidence score between 51% and 80%, and a third section including representative users associated with a confidence score between 81% and 100%. These confidence scores are only examples and any value may be used.

In some examples, the communication platform may enable a user to edit (e.g., using graphic identifier 418) or rearrange an order of the representative users (e.g., related people or users). The communication platform may then present, via the user interface associated with the group-based communication platform, the representative users based on the selected order. In some examples, the communication platform may enable a user to highlight (e.g., increase the size of, change the color of, bolden, italicize, etc.), star (e.g., favorite), or otherwise emphasize (e.g., with an indicator) one or more representative users according to a user's personal preferences.

In some examples, a machine-learning model may generate data representing one or more related people (or users) based at least in part on a number of related people already associated with a user's profile data. For example, a user's profile may be associated with a maximum number of related people (e.g., 3 related people, 5 related people, 20 related people, and the like). The maximum number of related people that may be presented on a user's profile page may be set by the communication platform, an organization, an administrator, or a user. In some examples, a user's profile may be associated with a minimum number of related people. For example, a user may not have less than 3 related people at any given time. A profile page associated with a maximum number of related people may still be updated (e.g., automatically or by a user) over time to include new related people (e.g., due to users either leaving or joining the communication platform or organization, changes in work relationships over time, or change in work projects generally, etc.) For example, the machine-learning model may recommend new related people to the user based on new or changing interaction data input into the machine-learning model over time. In some examples, the machine-learning model may update related users associated with a profile page based on a user's request to modify the profile data, detecting a threshold number of keywords or key phrase associated with the user or user account, detecting a threshold number of new user accounts, detecting a threshold number of users leaving an organization or the communication platform accounts being added to the communication platform, a threshold period of time elapsing, etc.

In some examples, the example user interface 400 may include any number of frequent topics 416 associated with a user account. Frequent topics 416 may include topics that a user account frequently discusses in messages, channels, and/or documents. In some examples, frequent topics 416 may include topics that the user account is considered an “expert” in or is interested in discussing with other users. For example, a machine-learning model may analyze certain topics (e.g., machine-learning, artificial intelligence, graphic design, etc.) discussed between all users or a group of users associated with the group-based communication platform and determine (based at least in part on comparing the data between users accounts) which users discuss (e.g., respond to questions relating to the topic, use key words or phrases associated with the topic, generate documents associated with the topic, etc.) the topic most frequently. A topic may be general or specific (e.g., machine learning v. machine-learning models specifically related to user accounts). In some examples, the machine-learning model may associate a topic with only a certain number of users or group of users. For example, the machine-learning model may associate a topic with only a top 1%, 5%, 10% of user accounts. Alternatively, or additionally, the machine-learning model may associate a maximum or minimum number of user accounts with a topic. For example, the machine-learning model may associate a topic with only 10, 15, or 20 user accounts of all user accounts on the group-based communication platform or between a certain group of users (e.g., between a group of inventors or researchers, an organization, a group of organizations, etc.). In some examples, the machine-learning model may automatically update topics associated with individual user accounts based at least in part on receiving additional interaction data, a passage of time, determining a certain number of new users have joined the communication platform, detecting a number of keywords or key phrases, receiving a request to update a topics section associated with an individual user account, or the like.

In some examples, the example user interface 400 may enable a user associated with the user account to edit information presented on the user account. For example, example user interface 400 may include a graphic identifier 418 associated with individual sections of the user account. For example, graphical identifier 418 may be associated with contact information 404, people 406, mentions and messages 408, channels 410, frequent channels 412, related people 414, frequent topics 416, or any other section associated with the user account. For example, selecting graphic identifier 418 associated with an individual section enables a user to edit (i.e., add, remove, rearrange, highlight, etc.) information associated with the individual section. In some examples, in response to receiving an indication that a user has edited information presented on the user account, the machine-learning model may automatically update other information associated with the user account. For example, a machine-learning model may detect that a user edited (e.g., added, removed, rearranged, etc.) information relating to one or more users or channels associated with the user account and, automatically, present the user with one or more representative users or representative channels the user may want to associate with the user account. In some examples, edits a user makes to the user's profile (e.g., adding, removing, rearranging users, channels, and/or topics associated with the profile page) may be input as training data into the machine-learning model.

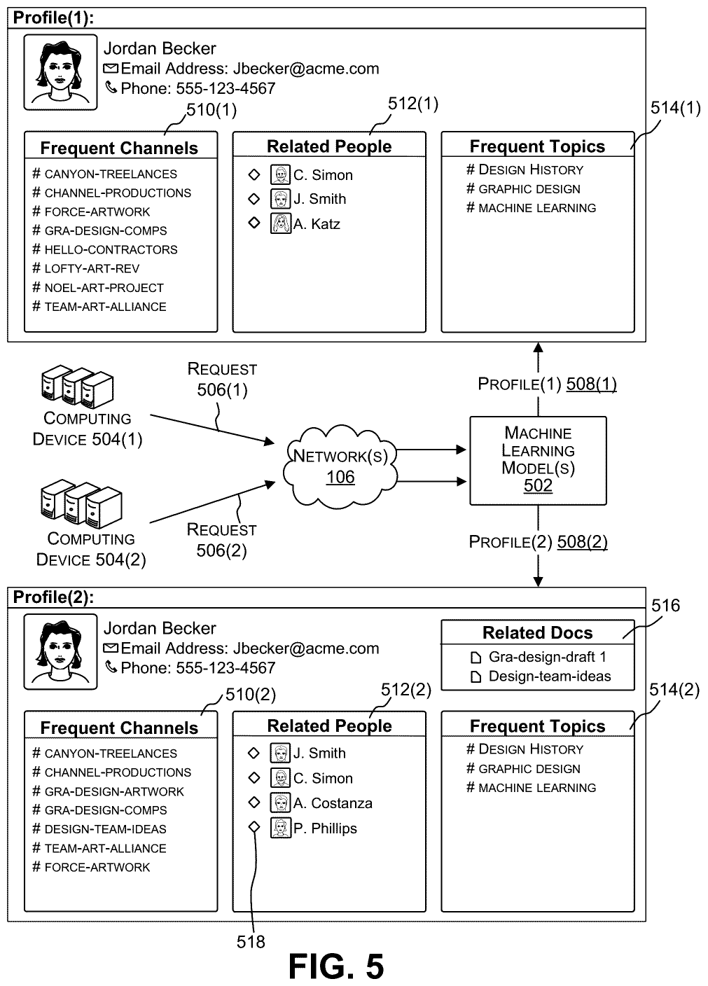

FIG. 5 illustrates example first and second user interfaces associated with a communication profile, as described herein, for displaying profile data associated with user account. In some examples, the communication platform may present a viewing user (e.g., second user) certain profile data associated with a first user account based in part on indications of user preferences, which may be explicitly indicated or learned using machine-learning model(s) 502. In some examples, profile data presented to the second user may be based on the second user's role, position, type of user account (e.g., whether the user is an administrator, a verified user, and/or the like), which can be determined based at least in part on an organizational chart and/or learned over time based on user interactions. For example, the communication platform may analyze messaging and/or other interaction data to determine relationships between users and/or relative ranks, roles, or positions. This allows a user viewing another user's profile to be presented with information (e.g., channels, users, etc.) that is most relevant to the viewing user.

In some examples, a machine-learning model(s) 502 may generate different profile data to be displayed in association with a first user account depending on which user is viewing the profile data. For example, the machine-learning model may generate different profile data based at least in part on interaction data associated with the user account viewing the profile data, interaction data associated with the viewing user and the user account associated with the profile data, one or more permissions or privacy setting, etc. For example, a second user account associated with computing device 504(1) may request 506(1) to view profile data (e.g., a profile page) associated with a first user account (e.g., Jordan Becker, as illustrated in FIG. 5). The machine-learning model(s) 502 may generate, based at least in part on the request, first profile data to be displayed on a first user interface 508(1) associated with computing device 504(1). The first profile data may include a first section 510(1) including one or more frequent channels, a second section 512(1) including one or more related people (or related users), and/or a third section 514(1) including one or more frequent topics associated with the first user account. Additionally, a third user associated with computing device 504(2) may also request 506(2) to view profile data (e.g., a profile page) associated with the first user account (e.g., Jordan Becker, as illustrated in FIG. 5). The machine-learning model(s) 502 may generate, based at least in part on the request, second profile data to be displayed on a second user interface 508(2) associated with computing device 504(2). The second profile data may include a first section 510(2) including one or more frequent channels, a second section 512(2) including one or more related people (or related users), and/or a third section 514(2) including one or more frequent topics associated with the user account.

In some examples, one or more of the sections may be associated with or more indicators that indicate additional information. For example, as illustrated in FIG. 5, the second section 512(2) may include an indicator 518 associated with individual users. Indicator 518 may indicate whether the individual user is currently active, part of the same organization as the viewing user (e.g., a second user associated with computing device 504(1)), whether the user is part of the same department as the viewing user, whether the user has worked with the user in the past, whether the user is associated with the viewing user's contact list, etc.

In some examples, the machine-learning model(s) 502 may present additional, fewer, or different profile data based at least in part on the user account that is viewing the profile data. For example, first interaction data associated with a first user account and second interaction data associated with a second user account may be input into machine-learning model(s) 502. The machine-learning model(s) 502 may then analyze the first and second interaction data and generate (as an output) first data representing one or more representative channels and second data representing one or more representative users to be associated with profile data of the first user account. The group-based communication platform may receive a request, from the second user account, to view profile data associated with the first user account. The representation component associated with the machine-learning model(s) 502 may then present, via a user interface, one or more representative channels and/or one or more representative users associated with the first user account to the second user account based at least in part on interaction data representing interactions between the first user account and the second user account. For example, one or more representative channels and/or one or more representative users may be presented based on channels and/or users that second user account may not already be associated with, channels and/or users the second user account may be interested in collaborating with, channels and/or users that work on similar projects or have similar backgrounds as the second user account, etc.

In some examples, machine-learning model(s) 502 may rearrange information presented in one or more sections depending on the interaction data associated with the user account that is viewing another user account's profile data. For example, as illustrated in FIG. 5, machine-learning model(s) 502 may present a second user associated with computing device 504(1) the “#FORCE-ARTWORK” channel as being the third channel in the first section 510(1) while presenting a third user associated with computing device 504(2) the “#FORCE-ARTWORK” channel as being the seventh channel in the first section 510(2). Similarly, as illustrated in FIG. 5, machine-learning model(s) 502 may present a second user associated with computing device 504(1) user “C. Simon” as being a first user in the first section 510(1) while presenting a third user associated with computing device 504(2) user “C. Simon” as being the second user in the first section 510(2).

In some examples, the machine-learning model(s) 502 may generate additional or different profile data based at least in part on the user account that is viewing the profile data. For example, as illustrated in FIG. 5, machine-learning model(s) 502 may generate related document data and present the user associated with the computing device 504(2) a fourth section 516 including one or more related documents. The machine-learning model may generate related documents based at least in part on interaction data (e.g., actions taken within channels, messages, documents) between the third user account and the first user account associated with the profile data (e.g., Jordan Becker, as illustrated in FIG. 5). For example, the machine-learning model(s) 502 may determine, based at least in part on input data, that the third user account and the first user account share one or more channels, have worked on one or more projects together, or are currently working on one or more documents together, are working on similar projects, are working with one or more of the same users, share similar roles or area of expertise, etc. The machine-learning model may then generate and present additional profile data, such as related document data included in the fourth section 516. The one or more documents included in the fourth section 516 may be documents the first and/or second user account is working on, documents that have been shared between the first and second user account, documents related to topics both users accounts are interested in, documents the second user account may be interested in viewing, etc.

In some examples, the communication platform may present a viewing user (e.g., a second user account) certain profile data associated with a first user account based on permissions data associated with the second user account and/or the first user account. For example, a user with first permissions (e.g., full access) can be presented with profile data associated with a first profile page, while another user with second permissions (e.g., partial access) can be presented with a second profile data associated with a second profile page different than the first profile data (e.g., the user may not be able to view certain contact information 404, mentions and messages 408, one or more channels in the frequent channels 412 section, one or more related people 414, or one or more frequent topics 416, and/or other information). In some examples, permissions can be set automatically by an administrator of the communication platform, a manager, an employer, enterprise, organization, team leader, group leader, an individual user, or other entity that utilizes the communication platform for communicating with users. In some examples, permissions may indicate which users can be associated with profile data of a user account, which channels can be associated with profile data of a user account, any restrictions on individual channels, restrictions on documents that can be shared, edited, or associated with profile data of a user account. For example, the communication platform may limit or prevent user accounts associated with a human resources department or information technology department to be associated with profile data of user accounts.

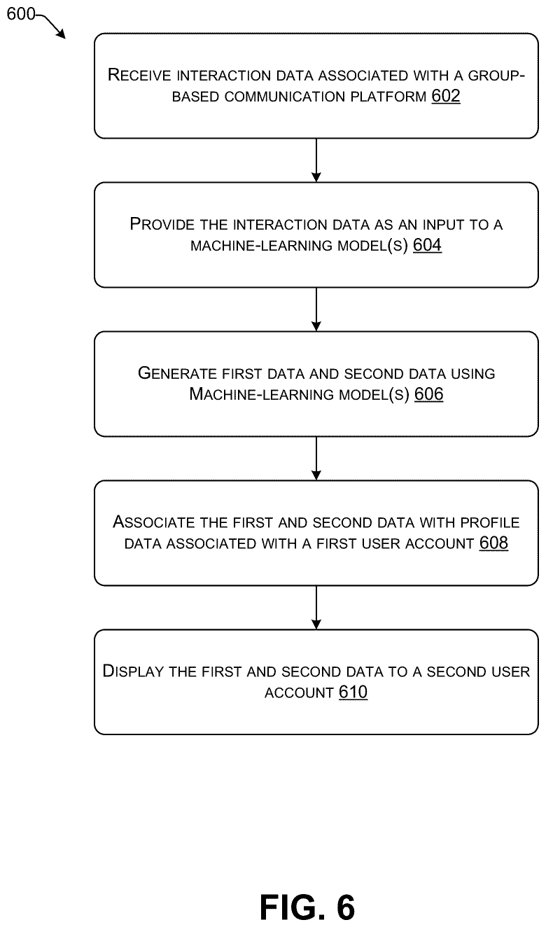

FIG. 6 is a flow diagram illustrating an example process of generating data associated with representative channels and representative users using machine-learning model(s) as described herein. Process 600 is illustrated as a collection of blocks in a logical flow diagram, representing sequences of operations, some or all of which can be implemented in hardware, software, or a combination thereof. In the context of software, the blocks represent computer-executable instructions stored on one or more computer-readable media that, when executed by one or more processors, perform the recited operations. Generally, computer-executable instructions include routines, programs, objects, components, encryption, deciphering, compressing, recording, data structures, and the like that perform particular functions or implement particular abstract data types. The order in which the operations are described should not be construed as a limitation. Any number of described blocks can be combined in any order and/or parallel to implement the processes, or alternative processes, and not all of the blocks need to be executed in all examples. For discussion purposes, the processes herein are described in reference to frameworks, architectures and environments described in the examples herein, although the processes may be implemented in a wide variety of other frameworks, architecture, and environments.

At operation 602, the process 600 may include receiving, from a first user account associated with a group-based communication platform, interaction data representing interactions between the first user account and at least one other user account or channel associated with the group-based communication platform. In some examples, interaction data may include a first user's interactions with the first user's own user account, interactions with one or more users (e.g., sending messages, responding to messages, sending and/or editing documents between users), interactions with one or more channels (e.g., creating a channel, sharing a channel with one or more users, posting content to a channel, etc.). As discussed above in relation to FIG. 4, interaction data may include a user's interactions with one or more channels, posts, relationship data, documents, and/or other interactions associated with the group-based communication platform.

At operation 604, the process 600 may include inputting the interaction data to a machine-learning model trained to determine one or more channels a user account actively interacts with and/or one or more users the user account actively interacts with via the group-based communication platform. In some examples, the machine-learning model may evaluate and analyze the interaction data associated with the group-based communication platform. In some examples, the machine-learning model may determine one or more topics a user account actively discusses or is interested in discussing with other users.

At operation 606, the process 600 may include generating, by the machine-learning model and based at least in part on the input, first data representing one or more representative channels and second data representing one or more representative users associated with the group-based communication platform. Representative channels may include channels a user most frequently interacts with or is most interested in. Representative users may include users that most frequently interact with the user account. Alternatively, or additionally, the machine-learning model may generate one or more topics a user frequently discusses or is interested in discussing with other users associated with the group-based communication platform.

At operation 608, the process 600 may include causing the first data representing the one or more representative channels and the second data representing the one or more representative users to be associated with profile data associated with the first user account. In some examples, the first data and the second data may be stored in a datastore. In some examples, the first data and the second data may first be presented to a user associated with the first user account before being associated with profile data. For example, the representation component associated with the machine-learning model may request a user accept, confirm, or deny the first data representing the one or more representative channels and/or the second data representing the one or more representative users to be associated with profile data. In some examples, the communication platform may request the user to set a permission or privacy setting with individual representative channels or representative users so that only certain users or groups of users may view one or more representative channels and/or representative users on the user's profile page.

At operation 610, the process 600 may include presenting, via a user interface associated with the group-based communication platform, the first data and the second data to a second user account. For example, the first data and the second data may be presented on a profile page associated with the first user account. In some examples, presenting the first data and the second data to the second user account is based at least in part on a privacy setting or permissions level associated with the first user account and the second user account. In some examples, presenting the first data and the second data to the second user account is based at least in part or on interaction data between the first user account and the second user account.

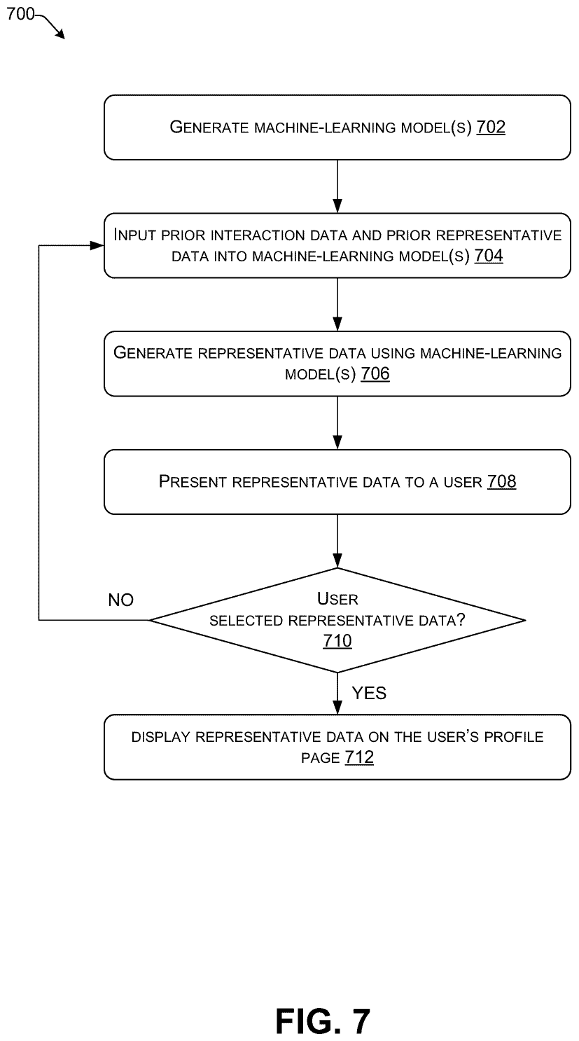

FIG. 7 is a flow diagram illustrating an example process for training machine-learning model(s) as described herein. The processes illustrated in FIG. 7 are described with references to components described above with reference to environment 100 shown in FIG. 1 for convenience and ease of understanding. However, the processes illustrated in FIG. 7 are not limited to being performed using the components described above with reference to the environment 100. Moreover, the components described above with reference to environment 100 are not limited to performing the processes illustrated in FIG. 7.

Process 700 is illustrated as a collection of blocks in a logical flow diagram, representing sequences of operations, some or all of which can be implemented in hardware, software, or a combination thereof. In the context of software, the blocks represent computer-executable instructions stored on one or more computer-readable media that, when executed by one or more processors, perform the recited operations. Generally, computer-executable instructions include routines, programs, objects, components, encryption, deciphering, compressing, recording, data structures, and the like that perform particular functions or implement particular abstract data types. The order in which the operations are described should not be construed as a limitation. Any number of described blocks can be combined in any order and/or parallel to implement the processes, or alternative processes, and not all of the blocks need to be executed in all examples. For discussion purposes, the processes herein are described in reference to frameworks, architectures and environments described in the examples herein, although the processes may be implemented in a wide variety of other frameworks, architecture, and environments.

At operation 702, the process 700 may include generating one or more machine-learning models. Machine-learning models may utilize predictive analytic techniques, which may include, for example, predictive modelling, machine learning, and/or data mining. Generally, predictive modelling may utilize statistics to predict outcomes. Machine learning, while also utilizing statistical techniques, may provide the ability to improve outcome prediction performance without being explicitly programmed to do so. A number of machine learning techniques may be employed to generate and/or modify the layers and/or models describes herein. Those techniques may include, for example, decision tree learning, association rule learning, artificial neural networks inductive logic programming, support vector machines, clustering, Bayesian networks, reinforcement learning, representation learning, similarity and metric learning, sparse dictionary learning, and/or rules-based machine learning. Information from stored and/or accessible data may be extracted from one or more databases, such as the datastore(s) 124, and may be utilized to predict trends and behavior patterns.

At operation 704, the process 700 may include training the machine-learning model at least in part by inputting prior interaction data and prior representative data into a machine-learning model. For example, profile content associated with one or more user accounts that include a frequent channels list, related users list, and/or frequent topics data may be input into the machine-learning model as training data. The machine-learning model may be trained to identify user preferences and/or apply a certain weight to interaction data. For example, the machine-learning model may assign apply a greater weight to more recent interaction data, certain types of communications between users (e.g., apply greater weight to sent messages as opposed to received messages), or types of channels (e.g., apply greater weight to channels created by a user as opposed to joining already created channels). The machine-learning model may learn relationships between prior user interaction data and prior representative data (e.g., prior representative channels, representative users, and/or representative topics) so that the machine-learning model may generate representative data that is more accurate over time.

At operation 706, the process 700 may include generating representative data using machine-learning model(s). For example, the representation component may utilize the machine-learning model to output data representing one or more representative channels, one or more representative users, and/or one or more representative topics. In some examples, the machine-learning model may assign a confidence score to individual representative channels, users, and/or topics. In some examples, the representation component may present the representative channels, representative users, and/or representative topics in an order according to a confidence score associated with individual representative data.

At operation 708, the process 700 may include presenting, via a user interface associated with the communication platform, representative data to a user. Representative data may include one or more representative channels, one or more representative users, and/or one or more representative topics a user may be interested in associating with the user's profile page. The user may select one or more channels, users, and/or topics to associate with the user's profile page.

At operation 710, the process 700 may include determining whether the user selected one or more of the representative data. In response to a user selection of one or more of the representative data, the process 700 may follow the “YES” route and proceed to 712. In some examples, the user may provide feedback to the machine-learning model on the accuracy of the representative data. If the user does not choose one or more of the representative channels, users, and/or topics, the process 700 may follow the “NO” route and proceed to 704, whereby the user's response can be input as prior representative data and used as training data to train the machine-learning model. In some examples, the communication platform may receive, from a user account a request to modify profile data associated with the user account. The machine-learning model may generate, based at least in part on the request and prior interaction data, a first list of representative channels and a second list of representative users associated with the user account. The representative channels and users may be channels and users the machine-learning model is recommending the user account associate with profile data. The communication platform may receive, from the user account, a selection of one or more representative channels and/or one or more representative users, wherein the selection represents a subset of representative channels from the first list and a subset of representative users from the second list. In some examples, the communication platform may provide the selection of the subset of representative channels and subset of representative users as input into the machine-learning model in order to train the machine-learning model. In some examples, the machine-learning model may, based at least in part on the input and prior interaction data, generate a third list of representative channels and/or a fourth list of representative users. The communication platform may cause the subset of representative channels and subset of representative users to be associated with the user account's profile data.

At operation 712, the process 700 may include displaying the selected representative data (or subset of representative data) on a profile page associated with the user account. In some examples, the communication profile may send a notification to the user when new representative data has been associated with the user's profile page.

### EXAMPLE CLAUSES

A: A method, implemented at least in part by one or more computing devices of a group-based communication platform, the method comprising: receiving, from a first user account associated with the group-based communication platform, interaction data representing interactions between the first user account and at least one of other user accounts or channels associated with the group-based communication platform; providing the interaction data as an input to a machine-learning model; generating, by the machine-learning model and based at least in part on the input, first data comprising one or more representative channels and second data comprising one or more representative users associated with the group-based communication platform; causing the first data comprising the one or more representative channels and the second data comprising the one or more representative users to be associated with profile data associated with the first user account; and presenting, via a user interface associated with the group-based communication platform, the first data and the second data to a second user account.

B: The method of paragraph A, wherein the machine-learning model is trained based on: (i) third data that includes prior interaction data including data representing interactions between prior channels and prior user accounts; and (ii) fourth data that includes prior representative channels and representative users associated with the prior interaction data, to learn relationships between the third data and fourth data, such that the machine-learning model is configured to use the learned relationship to generate the first data and the second data upon input of the interaction data.

C: The method either paragraph A or B, wherein the interaction data includes at least one of: a reaction to a message; a link associated with a message; a number of replies associated with a channel; a number of views associated with a channel; or an attachment within a channel.

D: The method of paragraph A-C, further comprising: receiving, from the machine-learning model, a confidence score associated with individual channels of the representative channels; determining an order for presenting the representative channels based on the confidence score; and presenting, via the user interface associated with the group-based communication platform, the representative channels based on the order.

E: The method of any one or paragraphs A-D, further comprising: providing a keyword or key phrase as the input to the machine-learning model; generating, by the machine-learning model and based at least in part on the input, third data representing a frequently discussed topic; and causing the third data to be associated with profile data associated with the first user account.

F: The method of any one of paragraphs A-E, wherein, generating the first data and the second data to be associated with the first user account is based at least in part on a maximum number of representative channels and a maximum number of representative users associated with the first user account.

G: The method of any one of paragraphs A-F, further comprising: receiving, from the first user account, a request to modify the profile data associated with the first user account; generating, based at least in part on the request and the interaction data, a first list of representative channels that are unrepresented in the profile data associated with the first user account; receiving, from the first user account, a selection of one or more representative channels, the selection representing a subset of representative channels from the first list of representative channels; providing the selection of the subset of representative channels from the first list of representative channels and the interaction data as the input to the machine-learning model; generating, by the machine-learning model and based at least in part on the input and the interaction data, a second list of representative channels; and causing display of the subset of representative channels on the profile data associated with the first user account.

H: The method of any one of paragraphs A-G, further comprising: receiving, from the first user account, a request to modify the profile data associated with the first user account; generating, based at least in part on the request and the interaction data, a first list of representative users that are unrepresented in the profile data associated with the first user account, the representative users representing users the first user account is most likely to interact with; receiving, from the first user account, a selection of one or more representative users, the selection representing a subset of representative users from the first list of representative users; providing the selection of the subset of representative users from the first list of representative users and the interaction data as the input to the machine-learning model; generating, by the machine-learning model and based at least in part on the input and the interaction data, a second list of representative users; and causing display of the subset of representative users on the profile data associated with the first user account.

I: The method of paragraph H, wherein the first list of representative users includes users based at least in part on one of: a number of shared channels between the user and individual users; activity level data associated with individual users associated with the shared channels; user reply data associated with individual users; or a number of keywords or key phrases used by individual users.

J: The method of paragraph A, wherein presenting the first data and the second data to the second user account is based at least in part on a permissions level associated with the first user account and the second user account.

K: The method of paragraphs A, further comprising: determining an occurrence of an event associated with the group-based communication platform, wherein the event comprises at least one of: receiving, from the first user account, a request to modify the profile data associated with the first user account; detecting a threshold number of a keyword or key phrase associated with the first user account; or a threshold period of time elapsing; and generating, by the machine-learning model and based at least in part on the occurrence of the event, third data representing additional one or more representative channels and fourth data representing additional one or more representative users associated with the group-based communication platform; and causing the third data and the fourth data to be associated with the profile data of the first user account.

L: A system comprising: one or more processors; and one or more non-transitory computer-readable media storing instructions that, when executed, cause the system to perform operations comprising: receiving, from a first user account associated with a group-based communication platform, interaction data representing interactions between the first user account and at least one of other user accounts or channels associated with the group-based communication platform; providing the interaction data as an input to a machine-learning model; generating, by the machine-learning model and based at least in part on the input, first data comprising one or more representative channels and second data comprising one or more representative users associated with the group-based communication platform; causing the first data comprising the one or more representative channels and the second data comprising the one or more representative users to be associated with profile data associated with the first user account; and presenting, via a user interface associated with a communication platform, the first data and the second data to a second user account.

M: The system paragraph L, the operations further comprising: receiving, from a third user account, a request to view the profile data associated with the first user account; and presenting, via the user interface associated with the communication platform, the first data and the second data to the third user account based at least in part on the interaction data representing interactions between the first user account and the third user account.

N: The system paragraph L, wherein the interaction data includes at least one of: a reaction to a message; a link associated with a message; a number of replies associated with a channel; a number of views associated with a channel; or an attachment within a channel.

O: The system paragraph L, the operations further comprising: providing a keyword or key phrase as the input to the machine-learning model; generating, by the machine-learning model and based at least in part on the input, third data representing a frequently discussed topic; and causing the third data to be associated with profile data associated with the first user account.

P: The system paragraph L, wherein generating the first data and the second data to be associated with the first user account is based at least in part on a maximum number of representative channels and a maximum number of representative users associated with the first user account.

Q: One or more non-transitory computer-readable media storing instructions that, when executed by one or more processors, cause the one or more processors to perform operations comprising: receiving, from a first user account associated with a communication platform, interaction data representing interactions between the first user account and at least one of other user accounts or channels associated with a group-based communication platform; providing the interaction data as an input to a machine-learning model; generating, by the machine-learning model and based at least in part on the input, first data comprising one or more representative channels and second data comprising one or more representative users associated with the group-based communication platform; causing the first data comprising the one or more representative channels and the second data comprising the one or more representative users to be associated with profile data associated with the first user account; and presenting, via a user interface associated with the communication platform, the first data and the second data to a second user account.

R: The one or more non-transitory computer-readable media of paragraph Q, wherein the one or more representative users includes users based at least in part on one of: a number of shared channels between the user and individual users; activity level data associated with individual users associated with the shared channels; user reply data associated with individual users; or a number of a key words or key phrases used by individual users.

S: The one or more non-transitory computer-readable media of paragraph Q, wherein the interaction data includes at least one of: a reaction to a message; a link associated with a message; a number of replies associated with a channel; a number of views associated with a channel; or an attachment within a channel.

T: The one or more non-transitory computer-readable media of paragraph Q, wherein presenting the first data and the second data to the second user account is based at least in part on a permissions level associated with the first user account and the second user account.

While the example clauses described above are described with respect to one particular implementation, it should be understood that, in the context of this document, the content of the example clauses can also be implemented via a method, device, system, a computer-readable medium, and/or another implementation. Additionally, any of examples A-T may be implemented alone or in combination with any other one or more of the examples A-T.

### CONCLUSION

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A method, implemented at least in part by one or more computing devices of a group-based communication platform, the method comprising:
receiving, from a first user account associated with the group-based communication platform, interaction data representing interactions between the first user account and at least one of other user accounts or channels associated with the group-based communication platform;
providing the interaction data as an input to a machine-learning model;
generating, by the machine-learning model and based at least in part on the input, first data comprising one or more representative channels and second data comprising one or more representative users associated with the group-based communication platform;
causing the first data comprising the one or more representative channels and the second data comprising the one or more representative users to be associated with profile data associated with the first user account; and
presenting, via a user interface associated with the group-based communication platform, the first data and the second data to a second user account.

2. The method of claim 1, wherein the machine-learning model is trained based on: (i) third data that includes prior interaction data including data representing interactions between prior channels and prior user accounts; and (ii) fourth data that includes prior representative channels and representative users associated with the prior interaction data, to learn relationships between the third data and fourth data, such that the machine-learning model is configured to use the learned relationship to generate the first data and the second data upon input of the interaction data.

3. The method of claim 1, wherein the interaction data includes at least one of:
a reaction to a message;
a link associated with a message;
a number of replies associated with a channel;
a number of views associated with a channel; or
an attachment within a channel.

4. The method of claim 1, further comprising:
receiving, from the machine-learning model, a confidence score associated with individual channels of the representative channels;
determining an order for presenting the representative channels based on the confidence score; and
presenting, via the user interface associated with the group-based communication platform, the representative channels based on the order.

5. The method of claim 1, further comprising:
providing a keyword or key phrase as the input to the machine-learning model;
generating, by the machine-learning model and based at least in part on the input, third data representing a frequently discussed topic; and
causing the third data to be associated with profile data associated with the first user account.

6. The method of claim 1, wherein generating the first data and the second data to be associated with the first user account is based at least in part on a maximum number of representative channels and a maximum number of representative users associated with the first user account.

7. The method of claim 1, further comprising:
receiving, from the first user account, a request to modify the profile data associated with the first user account;
generating, based at least in part on the request and the interaction data, a first list of representative channels that are unrepresented in the profile data associated with the first user account;
receiving, from the first user account, a selection of one or more representative channels, the selection representing a subset of representative channels from the first list of representative channels;
providing the selection of the subset of representative channels from the first list of representative channels and the interaction data as the input to the machine-learning model;
generating, by the machine-learning model and based at least in part on the input and the interaction data, a second list of representative channels; and
causing display of the subset of representative channels on the profile data associated with the first user account.

8. The method of claim 1, further comprising:
receiving, from the first user account, a request to modify the profile data associated with the first user account;
generating, based at least in part on the request and the interaction data, a first list of representative users that are unrepresented in the profile data associated with the first user account, the representative users representing users the first user account is most likely to interact with;
receiving, from the first user account, a selection of one or more representative users, the selection representing a subset of representative users from the first list of representative users;
providing the selection of the subset of representative users from the first list of representative users and the interaction data as the input to the machine-learning model;
generating, by the machine-learning model and based at least in part on the input and the interaction data, a second list of representative users; and
causing display of the subset of representative users on the profile data associated with the first user account.

9. The method of claim 8, wherein the first list of representative users includes users based at least in part on one of:
a number of shared channels between the user and individual users;
activity level data associated with individual users associated with the shared channels;
user reply data associated with individual users; or
a number of keywords or key phrases used by individual users.

10. The method of claim 1, wherein presenting the first data and the second data to the second user account is based at least in part on a permissions level associated with the first user account and the second user account.

11. The method of claim 1, further comprising:
determining an occurrence of an event associated with the group-based communication platform, wherein the event comprises at least one of:
receiving, from the first user account, a request to modify the profile data associated with the first user account;
detecting a threshold number of a keyword or key phrase associated with the first user account; or
a threshold period of time elapsing; and
generating, by the machine-learning model and based at least in part on the occurrence of the event, third data representing additional one or more representative channels and fourth data representing additional one or more representative users associated with the group-based communication platform; and
causing the third data and the fourth data to be associated with the profile data of the first user account.

12. A system comprising:
one or more processors; and
one or more non-transitory computer-readable media storing instructions that, when executed, cause the system to perform operations comprising:
receiving, from a first user account associated with a group-based communication platform, interaction data representing interactions between the first user account and at least one of other user accounts or channels associated with the group-based communication platform;
providing the interaction data as an input to a machine-learning model;
generating, by the machine-learning model and based at least in part on the input, first data comprising one or more representative channels and second data comprising one or more representative users associated with the group-based communication platform;
causing the first data comprising the one or more representative channels and the second data comprising the one or more representative users to be associated with profile data associated with the first user account; and
presenting, via a user interface associated with a communication platform, the first data and the second data to a second user account.

13. The system of claim 12, the operations further comprising:
receiving, from a third user account, a request to view the profile data associated with the first user account; and
presenting, via the user interface associated with the communication platform, the first data and the second data to the third user account based at least in part on the interaction data representing interactions between the first user account and the third user account.

14. The system of claim 12, wherein the interaction data includes at least one of:
a reaction to a message;
a link associated with a message;
a number of replies associated with a channel;
a number of views associated with a channel; or
an attachment within a channel.

15. The system of claim 12, the operations further comprising:
providing a keyword or key phrase as the input to the machine-learning model;
generating, by the machine-learning model and based at least in part on the input, third data representing a frequently discussed topic; and
causing the third data to be associated with profile data associated with the first user account.

16. The system of claim 12, wherein generating the first data and the second data to be associated with the first user account is based at least in part on a maximum number of representative channels and a maximum number of representative users associated with the first user account.

17. One or more non-transitory computer-readable media storing instructions that, when executed by one or more processors, cause the one or more processors to perform operations comprising:
receiving, from a first user account associated with a communication platform, interaction data representing interactions between the first user account and at least one of other user accounts or channels associated with a group-based communication platform;
providing the interaction data as an input to a machine-learning model;
generating, by the machine-learning model and based at least in part on the input, first data comprising one or more representative channels and second data comprising one or more representative users associated with the group-based communication platform;
causing the first data comprising the one or more representative channels and the second data comprising the one or more representative users to be associated with profile data associated with the first user account; and
presenting, via a user interface associated with the communication platform, the first data and the second data to a second user account.

18. The one or more non-transitory computer-readable media of claim 17, wherein the one or more representative users includes users based at least in part on one of:
a number of shared channels between the user and individual users;
activity level data associated with individual users associated with the shared channels;
user reply data associated with individual users; or
a number of a key words or key phrases used by individual users.

19. The one or more non-transitory computer-readable media of claim 17, wherein the interaction data includes at least one of:
a reaction to a message;
a link associated with a message;
a number of replies associated with a channel;
a number of views associated with a channel; or
an attachment within a channel.

20. The one or more non-transitory computer-readable media of claim 17, wherein presenting the first data and the second data to the second user account is based at least in part on a permissions level associated with the first user account and the second user account.
